(19) United States
(12) Patent Application Publication
(10) Pub. No.: US 2014/0210740 A1
(43) Pub. Date: Jul. 31, 2014

(54) PORTABLE APPARATUS HAVING PLURALITY OF TOUCH SCREENS AND SOUND OUTPUT METHOD THEREOF

(71) Applicant: SAMSUNG ELECTRONICS CO., LTD, SUWON-SI (KR)

(72) Inventor: Sang-hyup LEE, Suwon-si (KR)

(73) Assignee: SAMSUNG ELECTRONICS CO., LTD, SUWON-SI (KR)

(21) Appl. No.: 14/048,116

(22) Filed: Oct. 8, 2013

(30) Foreign Application Priority Data
Jan. 31, 2013 (KR) 10-2013-0010920

(51) Int. Cl. G06F 3/16; G06F 3/041

(52) U.S. Cl. CPC G06F 3/16; G06F 3/041
USPC 345/173

(57) ABSTRACT

A portable apparatus having a plurality of touch screens and a plurality of speakers outputs sounds in the plurality of speakers according to an output mode of a plurality of output modes determined according to an input angle between the plurality of touch screens and attributes of a plurality of applications executed in the plurality of touch screens, and provides a user haptic feedback corresponding to the sound output.

### CROSS-REFERENCE TO RELATED APPLICATIONS

This application claims priority under 35 U.S.C. §119 from Korean Patent Application No. 10-2013-0010920, filed on Jan. 31, 2013, in the Korean Intellectual Property Office, the disclosure of which is incorporated herein by reference in its entirety.

### BACKGROUND OF THE INVENTION

1. Field of the Invention

Apparatuses and methods consistent with exemplary embodiments of the present general inventive concept relate to a portable apparatus having a plurality of touch screens and a sound output method thereof, and more particularly, to a portable apparatus having a plurality of touch screens and a plurality of speakers, which changes sounds output from the plurality of speakers based on attributes of a plurality of applications executed in the plurality of touch screens, and a sound output method thereof.

2. Description of the Related Art

Desktop computers have at least one display apparatus (for example, a monitor) to enable user interaction. Portable apparatuses (for example, portable phones, smart phones, or tablet personal computers (PCs)) using touch screens have one display apparatus.

The desktop computers output sounds through a plurality of speakers using one sound source according to working environments. The portable apparatuses using one touch screen also outputs sounds through one or a plurality of speakers using one sound source.

The number of speakers installed in the portable apparatuses is typically less than that installed in the desktop computers and as such it is difficult to feel sound effects of various channels through the speakers.

### SUMMARY OF THE INVENTION

Additional features and utilities of the present general inventive concept will be set forth in part in the description which follows and, in part, will be obvious from the description, or may be learned by practice of the general inventive concept.

One or more exemplary embodiments of the present general inventive concept provide a portable apparatus having a plurality of touch screens and a plurality of speakers, which outputs sounds through the plurality of speakers according to output modes determined according to attributes of a plurality of applications executed in the plurality of touch screens, and a sound output method thereof.

One or more exemplary embodiments of the present general inventive concept provide a portable apparatus having a plurality of touch screens and a plurality of speakers, which displays screens of a plurality of applications in the plurality of touch screens, outputs sounds corresponding to the plurality of applications through the plurality of speakers, and mutually exchanges the screens of the plurality of applications according to consecutive movement of an additional touch, and a sound output method thereof.

One or more exemplary embodiments of the present general inventive concept provide a portable apparatus having a plurality of touch screens and a plurality of speakers, which displays screens of a plurality of applications in the plurality of touch screens, outputs sounds corresponding to the plurality of applications through the plurality of speakers, mutually exchanges the screens of the plurality of applications according to an additional touch or consecutive movement of the additional touch, and mutually exchanges the sounds output from the plurality of speakers according to the mutual exchange of the screens, and a sound output method thereof.

One or more exemplary embodiments of the present general inventive concept provide a portable apparatus having a plurality of touch screens and a plurality of speakers, which displays screens of a plurality of applications in the plurality of touch screens, outputs sounds corresponding to the plurality of applications through the plurality of speakers, mutually exchanges the screens of the plurality of applications according to an additional touch or consecutive movement of the additional touch, and provides a user haptic feedback in response to mutual exchange of the sounds output from the plurality of speakers according to the mutual exchange of the screens, and a sound output method thereof.

Exemplary embodiments of the present general inventive concept provide a method of outputting sound of a portable apparatus having a plurality of touch screens. The method may include detecting a first touch corresponding to a first shortcut and a second touch corresponding to a second shortcut among a plurality of shortcuts displayed in at least one of the plurality of touch screens, displaying a first application in a first touch screen and a second application in a second touch screen one by one in response to the first touch and the second touch, detecting an angle between a first housing including the first touch screen and a second housing including the second touch screen, determining one of a plurality of output modes based on the detected angle, an attribute of the first application, and an attribute of the second application, and outputting sounds through a plurality of speakers according to the determined output mode.

The displaying the first and second application may include displaying a screen of the first application in one of the first touch screen and the second touch screen, and displaying a screen of the second application in the other of the first touch screen and the second touch screen.

The attribute of each of the first and second applications may include at least one selected from the group consisting of a name of the application, contents executable in the application, and contents executed in the application.

The output mode may include at least one of on/off of sound output and volume adjustment corresponding to each of the plurality of speakers, and the outputting of the sounds may include outputting the sounds through speakers located in the first housing and speakers located in the second housing according, to the determined output mode.

The outputting of the sounds may include outputting the sounds by configuring the plurality of speakers as at least one of 2 channels, 2.1 channels, 4 channels, 5.1 channels, and 7.1 channels.

The output mode may be a mode which individually outputs a plurality of audio sources corresponding to contents executed in each of the plurality of applications through the plurality of speakers.

The method may further include detecting a third touch in the first touch screen, and mutually exchanging a display location of a screen of the first application and a display location of a screen of the second application in response to the consecutive movement of the detected third touch, the sounds output through the plurality of speakers being exchanged and output according to the mutual exchange of the display locations of the screens.

The consecutive movement of the third touch may be consecutive movement of the detected third touch from the first touch screen toward the second touch screen.

The consecutive movement may include drag, flick, and rotation.

The method may further include detecting a fourth touch in an object corresponding to exchange of a screen of the first application displayed in the first touch screen, and a screen of the second application, and mutually exchanging display locations of the screen of the first application and the screen of the second application in response to the detected fourth touch, the sounds output through the plurality of speakers being exchanged and output according to the mutual exchange of the display locations of the screens.

Exemplary embodiments of the present general inventive concept also provide a method of outputting sound of a portable apparatus having a plurality of touch screens and a plurality of speakers. The method may include detecting a first touch corresponding to a first shortcut and a second touch corresponding to a second shortcut among a plurality of shortcuts displayed in the any one of touch screens, displaying a first application and a second application in a first touch screen and a second touch screen one by one in response to the first touch and the second touch, detecting an angle between the first touch screen and the second touch screen in one flexible housing including the first touch screen and the second touch screen by using a sensor, determining an output mode based on the detected angle, an attribute of the executed first application, and an attribute of the second application, the attributes of the first and second applications including at least one of a name of the application and an extension of contents executed in the application, and outputting sounds through the plurality of speakers according to the determined output mode.

Exemplary embodiments of the present general inventive concept provide a portable apparatus including a plurality of speakers, a first touch screen configured to display a plurality of shortcuts corresponding to a plurality of applications, a second touch screen, a sensor configured to detect an angle between the first touch screen and the second touch screen, and a controller configured to control the plurality of speakers, the first touch screen, the second touch screen, and the sensor, the controller controlling the apparatus to detect a first touch corresponding to a first shortcut and a second touch corresponding to a second shortcut in the first touch screen, display a first application and a second application in the first touch screen and the second touch screen, respectively, in response to the first touch and the second touch, and controlling the apparatus to determine an output mode based on the detected angle, an attribute of the first application, and an attribute of the second application, and output sounds through the plurality of speakers according to the determined output mode.

The portable apparatus may further include a hinge configured to connect a first housing including the first touch screen and one or more speakers of the plurality of speakers and a second housing including the second touch screen and one or more speakers of the plurality of speakers.

The sensor may be located in at least one of the first housing, the second housing, and the hinge.

Portions of the plurality of speakers may be located in at least one of a front side of the first housing in which the first touch screen is located, a back side of the first housing, and a side of the first housing connecting the front side of the first housing and the back side of the first housing, and portions of the plurality of speakers may be located in at least one of a front side of the second housing in which the second touch screen is located, a back side of the second housing, and a side of the second housing connecting the front side of the second housing and the back side of the second housing.

The plurality of speakers may include at least one of a woofer and a center speaker, and the woofer may be located in one of the first housing and the second housing.

The controller may mutually exchange a display location of a screen of the first application and a display location of a screen of the second application in response to consecutive movement of a third touch detected in the first touch screen, and exchange the sounds output through the plurality of speakers in response to the mutual exchange of the display locations and output the exchanged sounds through the plurality of speakers.

The controller may mutually exchange a display location of a screen of the first application and a display location of a screen of the second application in response to a fourth touch detected in an object displayed in the first touch screen corresponding to the exchange of the screen of the first application and the screen of the second application, exchange the sounds output through the plurality of speakers according to the exchange of the display locations of the screens, and output the exchanged sounds through the plurality of speakers.

The portable apparatus may further include one flexible housing including the plurality of speakers, the first touch screen, the second touch screen, and the sensor. An angle between the first touch screen and the second touch screen may be measured in the flexible housing.

Exemplary embodiments of the present general inventive concept also provide a method of outputting sound of a portable apparatus having a first touch screen and a second touch screen. The method may include detecting a first touch corresponding to a first shortcut displayed in the first touch screen in a first housing including a first speaker group and the first touch screen, executing a first application corresponding to the first shortcut and displaying the first application in a second touch screen of a second housing including a second speaker group and the second touch screen and separated from the first housing, detecting a second touch corresponding to a second shortcut in the first touch screen, executing a second application corresponding to the second shortcut and displaying the second application in the first touch screen, and outputting sounds in the second speaker group according to a first output mode of a plurality of output modes determined based on an attribute of the first application, and outputting sounds in the first speaker group according to a second output mode of the plurality of output modes determined based on an attribute of the second application.

The method may further include mutually exchanging a display location of a screen of the first application and a display location of a screen of the second application in response to a third touch detected in the first touch screen, exchanging the sounds output through the first speaker group and the sounds output through the second speaker group according to the mutual exchange of the display locations, and outputting the exchanged sounds.

The method may further include determining an angle between the first housing and the second housing. The angle may be determined using at least one of an angle sensor embedded in the portable apparatus and a user input.

A non-transitory computer-readable recording medium may contain computer-readable codes as a program to execute the method of outputting sound of the portable apparatus having the plurality of touch screens.

Exemplary embodiments of the present general inventive concept provide a portable apparatus, including a first touch screen, a second touch screen, a sensor configured to detect a status of the portable apparatus, and a controller configured to control the first touch screen, the second touch screen, and the sensor, the controller controlling the first touch screen and the second touch screen to display a first application and a second application, respectively, and determine an output mode of the apparatus based on the detected status, the first application, and the second application.

The controller may output sounds through a plurality of speakers according to the first and second applications and the determined output mode.

The portable apparatus may further include an input unit configured to interact with the first and second touch screens.

The input unit may provide haptic feedback to a user.

The sensor may include at least one of a proximity sensor, an angle sensor, an illuminance sensor, an acceleration sensor, a gyro sensor, a gravity sensor, and an altimeter.

Exemplary embodiments of the present general inventive concept also provide a method of operating a portable apparatus, the method including displaying a first and second application respectively in a first and a second touch screen, detecting a status of the portable apparatus, and determining an output mode of the portable apparatus based on the detected status and the first and second applications.

The method may further include providing haptic feedback according to the determined output mode and touch inputs on the first and second touch screens.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIGS. 1A and 1B are views schematically illustrating a portable apparatus according to an exemplary embodiment of the present general inventive concept;

FIG. 2 is a series of perspective views schematically illustrating a portable apparatus according to exemplary embodiments of the present general inventive concept;

FIG. 3 is a schematic block diagram illustrating a portable apparatus according to an exemplary embodiment of the present general inventive concept;

FIG. 4 is a schematic block diagram illustrating a portable apparatus according to another exemplary embodiment of the present general inventive concept;

FIG. 5 is a flowchart schematically illustrating a sound output method of a portable apparatus according to an exemplary embodiment of the present general inventive concept;

FIGS. 6A to 6F are views illustrating sound output methods of a portable apparatus according to an exemplary embodiment of the present general inventive concept;

FIGS. 7A to 7F are views illustrating sound output methods of a portable apparatus according to another exemplary embodiment of the present general inventive concept;

FIGS. 8A to 8D are views illustrating sound output methods of a portable apparatus according to other exemplary embodiments of the present general inventive concept;

FIG. 9 is a schematic flowchart illustrating setting-up of a sound output mode according to an exemplary embodiment of the present general inventive concept; and

FIG. 10 is a view illustrating examples of setting-up of a sound output mode according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

In the following description, same reference numerals are used for the same elements when they are depicted in different drawings. The matters defined in the description, such as detailed construction and elements, are provided to assist in a comprehensive understanding of the exemplary embodiments of the present general inventive concept. Thus, it is apparent that the exemplary embodiments of the present general inventive concept can be carried out without those specifically defined matters. Also, functions or elements known in the related art are not described in detail since they would obscure the exemplary embodiments with unnecessary detail.

Here, it will be understood that, although the terms first, second, etc. may be used herein in reference to elements of the present general inventive concept, such elements should not be construed as limited by these terms. For example, a first element could be termed a second element, and a second element could be termed a first element, without departing from the scope of the present general inventive concept. Herein, the term “and/or” includes any and all combinations of one or more referents.

The terminology used herein to describe exemplary embodiments of the present general inventive concept is not intended to limit the scope of the present general inventive concept. The articles “a,” “an,” and “the” are singular in that they have a single referent, however the use of the singular form in the present document should not preclude the presence of more than one referent. In other words, elements of the present general inventive concept referred to in the singular may number one or more, unless the context clearly indicates otherwise. It will be further understood that the terms “comprises,” “comprising,” “includes,” and/or “including,” when used herein, specify the presence of stated features, items, steps, operations, elements, components, and/or group thereof, but not preclude the presence or addition of one or more other features, items, steps, operations, elements, components, and/or groups thereof.

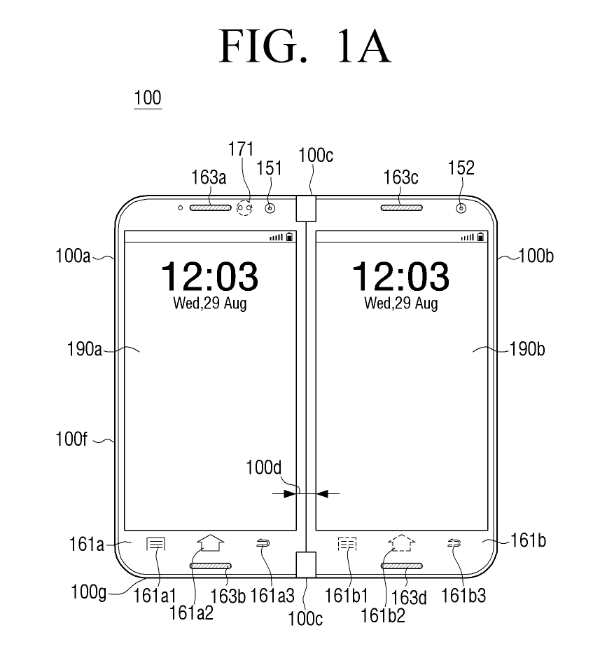

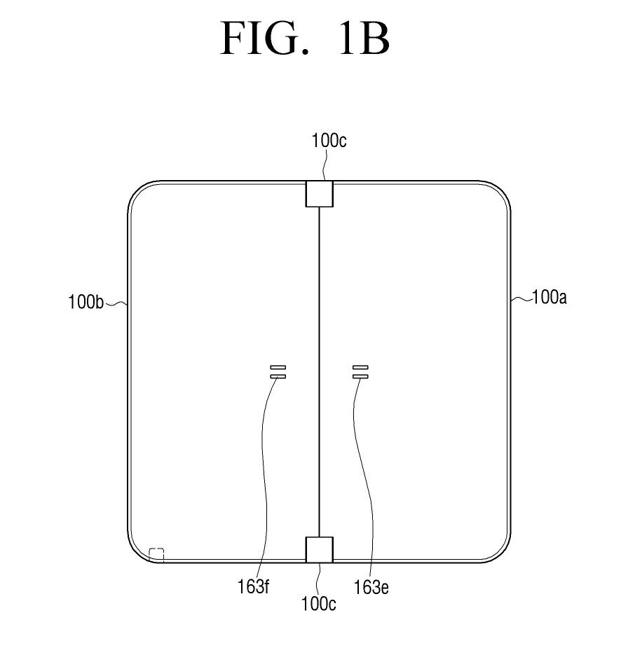

FIGS. 1A and 1B are schematic views illustrating a portable apparatus 100 according to an exemplary embodiment of the present general inventive concept.

Referring to FIG. 1, a portable apparatus 100 having a plurality of touch screens 190 and a plurality of speakers 163 may include a first housing 100a and a second housing 100b of which sides are connected by a hinge or flexible plastic 100c. Here, a first touch screen 190a and a second touch screen 190b are juxtaposed and spaced from each other by a distance 100d in central portions of front sides of the first housing 100a and the second housing 100b. The portable apparatus 100 having the plurality of touch screens 190 and the plurality of speakers may also include one flexible housing (not illustrated).

A first camera 151 configured to shoot (or image) a still image or a moving image, a proximity sensor (not illustrated) configured to detect the approach of a user or an object, and a first speaker 163a configured to output voice and/or sound to the outside of the portable apparatus 100 are located in an upper portion of the front side of the first housing 100a, and the first touch screen 190a is located in the central portion of the front side thereof. A second speaker 163b configured to output voice and/or sound to the outside of the portable apparatus 100 is located in a lower portion of the front side of the first housing 100a, and a first button group 161a including one button 161a2 or a plurality of buttons 161a1 to 161a3 is located in the lower portion of the front side thereof.

A second camera 152 configured to shoot a still image or a moving image, and a third speaker 163c configured to output voice and/or sound to the outside of the portable apparatus 100 are located in an upper portion of the front side of the second housing 100b, and the second touch screen 190b is located in the central portion of the front side thereof. A fourth speaker 163d configured to output voice and/or sound to the outside of the portable apparatus 100 is located in a lower portion of the front side of the second housing 100b, and a second button group 161b including one button 161b2 or a plurality of buttons 161b1 to 161b3 is located in the lower portion of the front side thereof. Here, the first button group 161a and the second button group 161b may be implemented with physical buttons, touch buttons, or a combination thereof.

Referring to FIG. 1B, a fifth speaker 163e configured to output voice and/or sound to the outside of the portable apparatus 100 is located in a back side of the first housing 100a. An input unit (not illustrated) using an electromagnetic induction method may be located in a lower portion of the back side of the first housing 100a. The touch screens 190a and 190b of the portable apparatus 100 according to an exemplary embodiment of the present general inventive concept may be modified into touch screens 190 (not illustrated) corresponding to an input of the input unit 167 operated as an electromagnetic induction method.

A sixth speaker 163f configured to output voice and/or sound to the outside of the portable apparatus 100 is located in a back side of the second housing 100b.

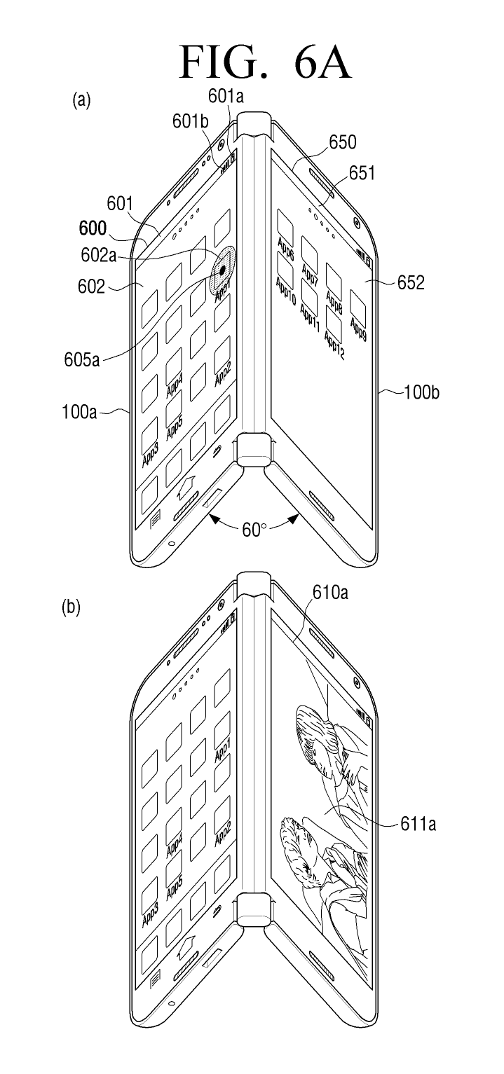

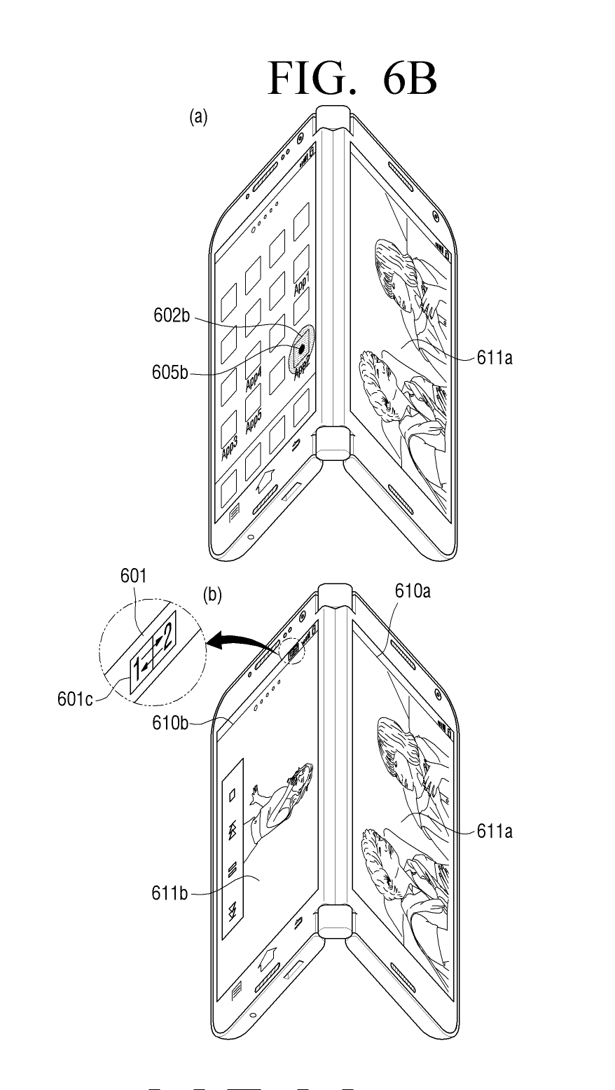

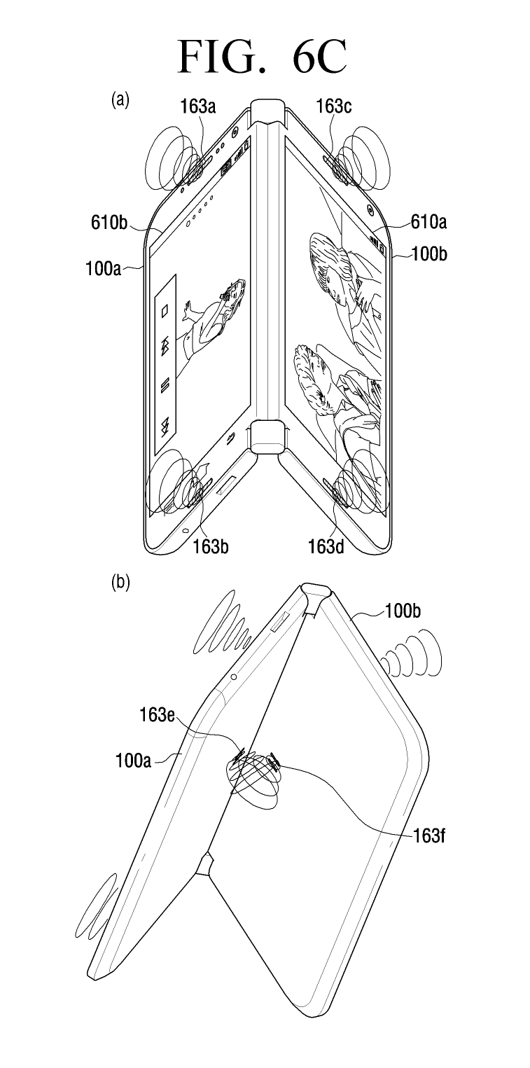

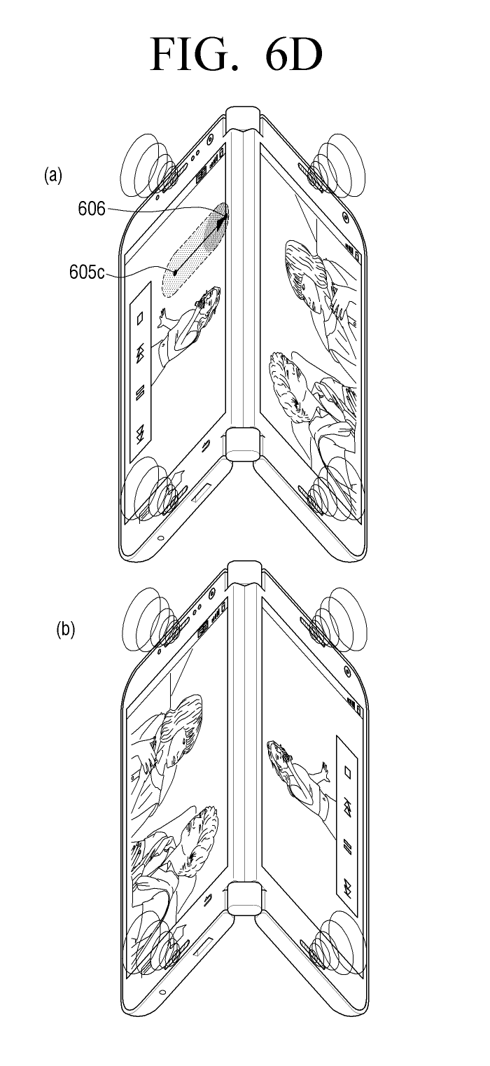

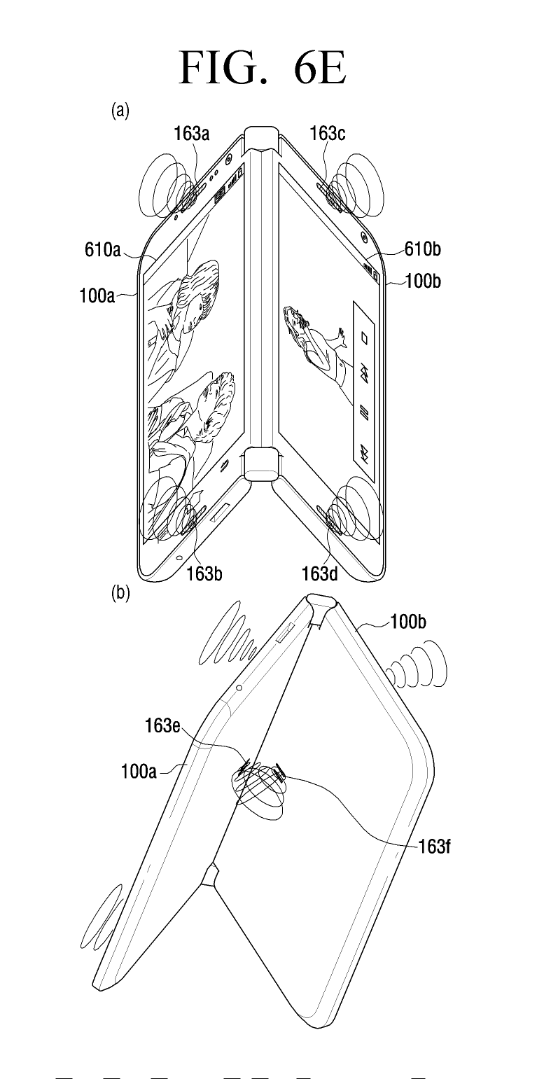

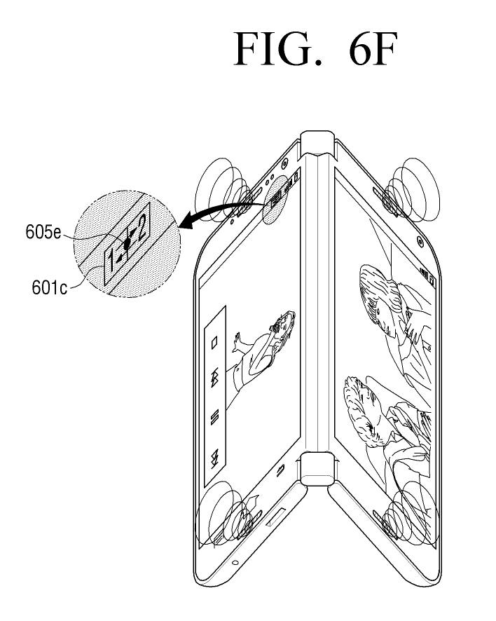

A more detailed description of speakers 163a through 163f according to an exemplary embodiment of the present general inventive concept is provided below with reference to FIG. 6C.

Although the exemplary embodiment of the present general inventive concept illustrated in FIGS. 1A to 1B includes two cameras 151 and 152, two touchscreens 190a and 190b, six speakers 163a through 163f, and so forth, the present general inventive concept is not limited to this configuration. One or more of the components of the portable apparatus 100 illustrated in FIGS. 1A and 1B may be omitted according to the performance of the portable apparatus, and one or more components may be added to the portable apparatus 100 according to the performance of the portable apparatus. Change in the locations of the components according to the performance or a structure of the portable apparatus 100 will be easily understood by the person having ordinary skill in the art.

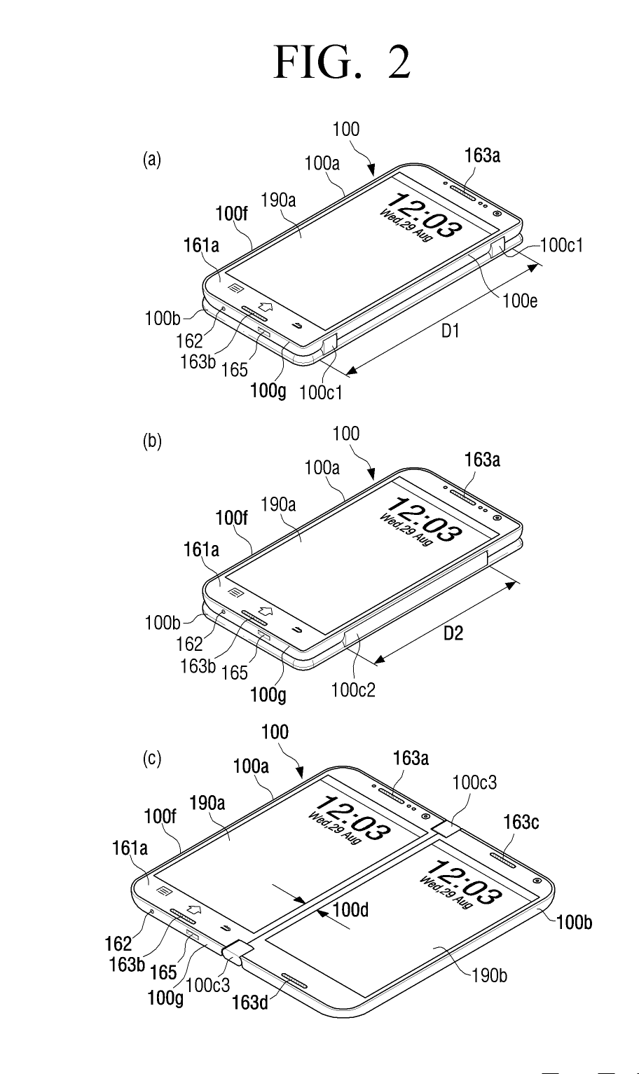

FIG. 2 is a series of schematic perspective views illustrating a portable apparatus 100 according to exemplary embodiments of the present general inventive concept.

Referring to views (a) and (b) of FIG. 2, the first housing 100a and the second housing 100b of the portable apparatus 100 are in a folded state, that is, an angle between the first housing 100a and the second housing 100b is about 0 (zero) degrees. Referring to FIGS. 1A and 1B, and view (c) of FIG. 2, the first housing 100a and the second housing 100b of the portable apparatus 100 are in an unfolded state, that is, the angle between the first housing 100a and the second housing 100b is about 180 degrees.

Hinges 100c1, 100c2, or 100c3 are located between the first housing 100a and the second housing 100b to open and close the first and second housings 100a and 100b. The first housing 100a and the second housing 100b may move to a predetermined angle in a range of 0 (zero) degree to 360 degrees through the hinges 100c1, 100c2, or 100c3. Views (a), (b) and (c) of FIG. 2 respectively illustrate different exemplary embodiments of the present general inventive concept, each illustrating one of hinges 100c1, 100c2, and 100c3.

Referring to view (a) of FIG. 2, in the folded state, the back side of the first housing 100a and the back side of the second housing 100b are parallel to each other, or alternatively they face each other. That is, the angle formed by the back side of the first housing 100a and the back side of the second housing 100b is equal to or less than 4 degrees. Further, the back side of the first housing 100a and the back side of the second housing 100b may be in contact with each other or spaced from each other by a predetermined gap (for example, 5 mm or less).

At least one of a power/lock button (not illustrated) and a volume button (not illustrated) is located in a side 100f of the first housing 100a. For example, only the power/lock button, only the volume button, or both the power/lock button and volume button may be located in the side 100f of the first housing.

A microphone 162 (also referred to as “mike” 162) and a connector 165 are located in a bottom 100g of the first housing 100a.

In the exemplary embodiment of the present general inventive concept illustrated in view (a) of FIG. 2, a plurality of hinges 100c1 are spaced from each other by a distance D1 to connect both ends of sides of the first and second housings 100a and 100b. In the folded state, a distance (not illustrated) from the first touch screen 190a of the portable apparatus 100 to an edge 100e of the first housing 100a is in a range of within ½±2 mm.

The first touch screen 190a and the second touch screen 190b are located substantially parallel to a plane perpendicular to both hinges 100c1. As illustrated in view (a) of FIG. 2, a length of each of the first and second touch screens 190a and 190b is shorter than the distance D1. Alternatively, the first and second touch screens 190a and 190b may be formed so that the length of each of the first and second touch screens 190a and 190b is equal to or greater than the distance D1. Further, the touch screens 190a and 190b have a quadrangular shape in the exemplary embodiment of the present general inventive concept, but various modifications in the shapes or arrangement directions of the touch screens 190a and 190b are possible. FIG. 1A may be a view illustrating a state in which the portable apparatus 100, which has been folded in view(a) of FIG. 2, becomes unfolded.

Referring to view (b) of FIG. 2, a portable apparatus 100 according to another exemplary embodiment of the present general inventive concept includes a first housing 100a, a second housing 100b, and one hinge 100c2. The first housing 100a and the second housing 100b are in a folded state. The hinge 100c2 connects middle portions of sides of the folded first and second housings 100a and 100b.

An arrangement of the front side, an arrangement of a side 100f including at least one of a power/lock button and a volume button, and an angle between the first and second housings 100a and 100b in the portable apparatus 100 may be substantially the same as those in the portable apparatus 100 illustrated in view (a) of FIG. 2, and thus detailed description thereof will be omitted.

As illustrated in view (b) of FIG. 2, a length of each of the first and second touch screens 190a and 190b is longer than a distance D2. Alternatively, the first and second touch screens 190a and 190b may be formed so that the length of each of the first and second touch screens 190a and 190b may be equal to or less than the distance D2. FIG. 1A may be a view illustrating a state in which the portable apparatus 100, which has been folded in view (b) of FIG. 2, becomes unfolded.

Referring to FIG. 2(c), a portable apparatus 100 according to another exemplary embodiment of the present general inventive concept includes a first housing 100a, a second housing 100b, and a plurality of hinges 100c3. Unlike views (a) and (b) of FIG. 2, in this exemplary embodiment of the present general inventive concept the plurality of hinges 100c3 connecting the first and second housings 100a and 100b are exposed in a front side of the first housing 100a and a front side of the second housing 100b as illustrated in view (c) FIG. 2.

An arrangement of the front side, an arrangement of a side, and an angle between the first and second housings 100a and 100b in the portable apparatus 100 may be substantially the same as those in the portable apparatus 100 illustrated in view (a) of FIG. 2, and thus detailed description thereof will be omitted.

As illustrated in view (c) of FIG. 2, a distance 100d between the first housing 100a and the second housing 100b is formed similar to the distance 100d of FIG. 1A.

The hinges 100c1, 100c, and 100c3 may be biaxial hinges (not illustrated) configured to rotate the first housing 100a or the second housing 100b using a first hinge axis (not illustrated) corresponding to the first housing 100a and a second hinge axis (not illustrated) corresponding to the second housing 100b.

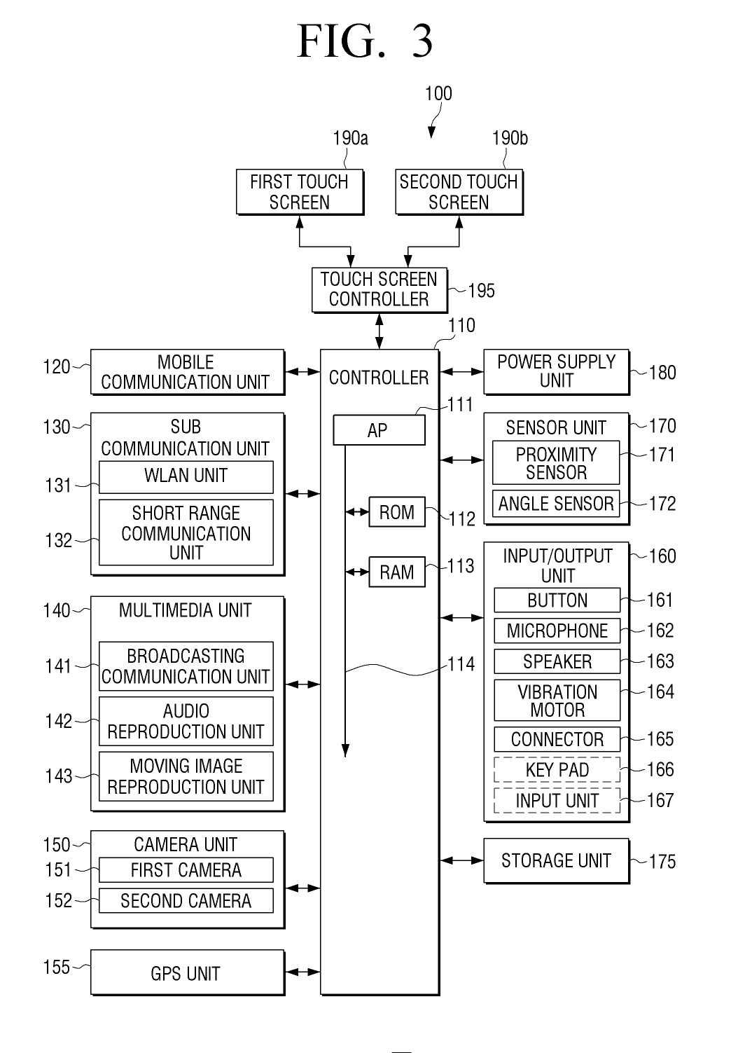

An angle sensor (172, illustrated in FIG. 3) configured to detect the angle between the first housing 100a and the second housing 100b may be located in the hinges 100c1, 100c2, and 100c3. The angle sensor 172 will be described below with reference to FIG. 3.

FIG. 3 is a schematic block diagram illustrating a portable apparatus 100 according to an exemplary embodiment of the present general inventive concept.

Referring to FIG. 3, a portable apparatus 100 may be connected to an external apparatus (not illustrated) using a mobile communication unit 120, a sub communication unit 130, and a connector 165. The external apparatus may include other portable apparatuses (not illustrated), such as a portable phone, a smart phone, and a tablet PC, as well as a server (not illustrated).

The portable apparatus 100 includes a first touch screen 190a, a second touch screen 190b, and a touch screen controller 195. The portable apparatus 100 further includes a controller 110, the mobile communication unit 120, the sub communication unit 130, a multimedia unit 140, a camera unit 150, a global positioning system (GPS) unit 155, an input/output unit 160, a sensor unit 170, a storage unit 175, and a power supply unit 180. The sub communication unit 130 includes at least one of a wireless local area network (WLAN) unit 131, and a short range communication unit 132. The multimedia unit 140 includes at least one of a broadcasting communication unit 141, an audio reproduction unit 142, and a moving image reproduction unit 143. The camera unit 150 includes at least one of a first camera 151 and a second camera 152. The input/output unit 160 includes at least one of a button 161, a microphone 162, a speaker 163, a vibration motor 164, the connector 165, a key pad 166, and an input unit 167. The sensor unit 170 includes a proximity sensor 171 and an angle sensor 172.

The controller 110 may include an application processor (AP) 111, a read only memory (ROM) 112 configured to store a control program to control the portable apparatus 100, and a random access memory (RAM) 113 configured to store a signal or data input from the outside of the portable apparatus 100 or to be used as a storage region for a job performed in the portable apparatus 100. The AP 111, the ROM 112, and the RAM 113 may be mutually connected through an internal bus 114.

The controller 110 controls an overall operation of the portable apparatus 100 and signal flow between internal components 120 to 195 of the portable apparatus 100, and performs a data processing function. The controller 110 controls power supply from the power supply unit 180 to the internal components 120 to 195. Further, the controller 110 executes an operating system (not illustrated) and an application (not illustrated) stored in the storage unit 175.

The AP 111 may include a graphic processing unit (GPU) (not illustrated) to perform graphic processing. The AP 111 may be a system on chip (SOC) including a core (not illustrated) and a GPU. The AP 111 may include a single core, dual cores, triple cores, quad cores, and multiple cores.

The controller 110 may control the mobile communication unit 120, the sub communication unit 130, the multimedia unit 140, the camera unit 150, the GPS unit 155, the input/output unit 160, the sensor unit 170, the storage unit 175, the power supply unit 180, the first touch screen 190a, the second touch screen 190b, and the touch screen controller 195.

The controller 110 may control to detect a plurality of touches corresponding to a plurality of shortcuts displayed in a touch screen 190a or 190b, and display a plurality of applications corresponding to the plurality of shortcuts in a plurality of touch screens 190a and 190b one by one, and control an angle sensor 172 to detect an angle between a first housing 100a including a first touch screen 190a and a second housing 100b including a second touch screen 190b, and output sounds through a plurality of speakers 163 according to one of a plurality of output modes determined based on the detected angle, an attribute of a first application, and an attribute of a second application.

The controller 110 may control a screen of the executed first application to be displayed in one of the first touch screen 190a and the second touch screen 190b, and a screen of the second application to be displayed in the other of the first touch screen 190a and the second touch screen 190b.

The controller 110 may control sounds to be output through speakers located in the first housing and the second housing according to the predetermined output mode. The controller may control on/off of the sound output from each of the speakers or adjust volume of each of the speakers.

The controller 110 may control the sounds to be output through the plurality of speakers 163 using a sound source corresponding to contents executed in the plurality of applications.

The controller 110 may exchange the screen of the first application and the screen of the second application in response to consecutive movements of multi touches corresponding to the exchange of the screens. The controller 110 may control the sounds output through the plurality of speakers 163 to be exchanged and output according to the screen exchange.

The controller 110 may detect the consecutive movements of the multi touches detected in one touch screen 190a or 190b to a bezel to determine movement toward a location in which other touch screen 190a or 190b is located.

The controller 110 may exchange the screen of the first application and the screen of the second application in response to a touch detected in an object corresponding to a screen exchange operation. The controller 110 may control the sounds output through the plurality of speakers 163 to be exchanged and output according to the screen exchange operation. In some exemplary embodiments of the present general inventive concept, the user may feel various sound output effects through the plurality of applications and the plurality of speakers 163.

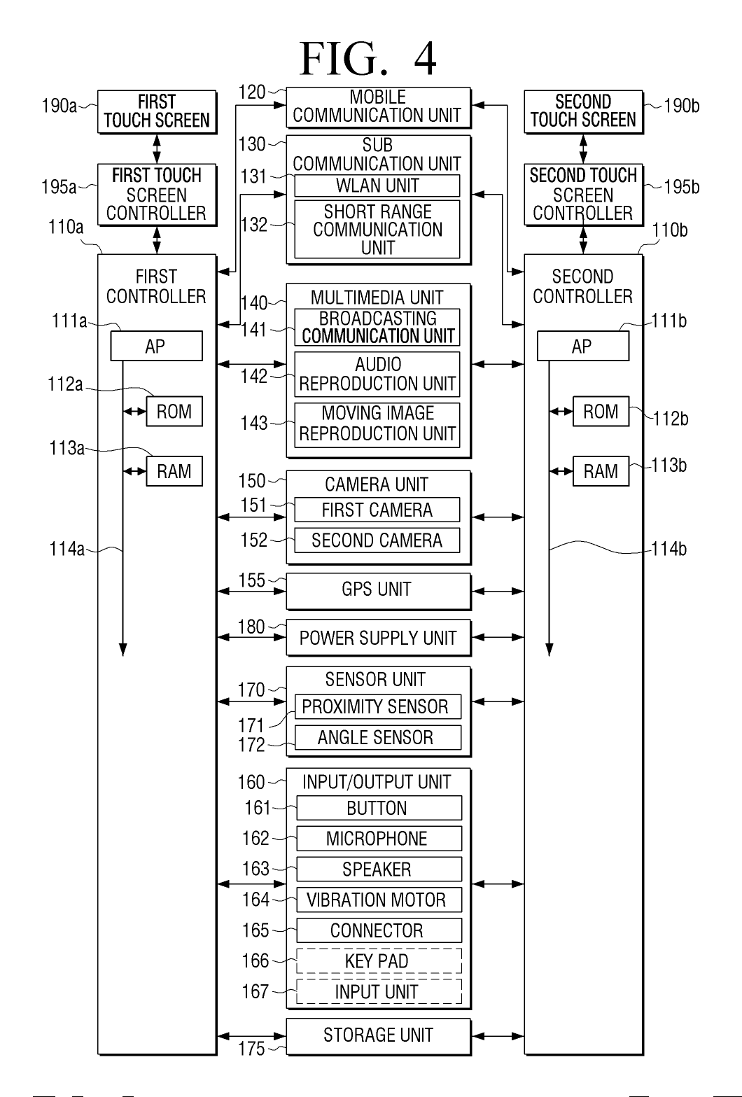

Here, the term “controller” includes the controller 110, a first controller (110a, illustrated in FIG. 4), or a second controller (110b, illustrated in FIG. 4).

The mobile communication unit 120 connects the portable apparatus 100 to an external apparatus through mobile communication using one or a plurality of antennas (not illustrated) under control of the controller 110. The mobile communication unit 120 transmits/receives a radio signal for voice calls, video calls, short message service (SMS), multimedia message service (MMS), and data communication to/from a portable phone (not illustrated), a smart phone (not illustrated), a tablet PC (not illustrated), or other portable apparatuses (not illustrated) having a phone number to be input to the portable apparatus 100.

The sub communication unit 130 may include at least one of the WLAN unit 131 and the short range communication unit 132. For example, the sub communication unit 130 may include only the WLAN unit 131, only the short range communication unit 132, or both the WLAN unit 131 and short range communication unit 132.

The WLAN unit 131 may be connected to Internet in a wireless manner in a place, in which an access point (AP) (not illustrated) is installed, under control of the controller. The WLAN unit 131 supports a WLAN standard (IEEE802.11x) of institute of electrical and electronics engineers (IEEE). The short range communication unit 132 may perform short range communication in a wireless manner between the portable apparatus 100 and an external apparatus under control of the controller. The short range communication may constitute for example one or more of Bluetooth, infrared data association (IrDA), and a near field communication (NFC).

The portable apparatus 100 may include at least one of the mobile communication unit 120, the WLAN unit 131, and the short range communication unit 132 according to the performance thereof. For example, the portable apparatus 100 may include a combination of the mobile communication unit 120, the WLAN unit 131, and the short range communication unit 132 according to the performance thereof.

The multimedia unit 140 may include the broadcasting communication unit 141, the audio reproduction unit 142, or the moving image reproduction unit 143. The broadcasting communication unit 141 may receive a broadcast signal (for example, a television (TV) broadcast signal, a radio broadcast signal, or a digital broadcast signal) and additional broadcast information (for example, an electric program guide (EPS) or an electric service guide (ESG)) sent from an external broadcasting station through a broadcasting communication antenna (not illustrated), and reproduce the broadcast signal and the additional broadcast information using a touch screen, a video codec unit (not illustrated), and an audio codec unit (not illustrated), under control of the controller 110. The audio reproduction unit 142 may reproduce a sound source (for example, an audio file of which a file extension is mp3, wma, ogg, or way) pre-stored in the storage unit 175 of the portable apparatus 100 or received from the outside of the portable apparatus 100 using an audio codec unit under control of the controller 110. The moving image reproduction unit 143 may reproduce a digital moving image file (for example, a file of which a file extension is mpeg, mpg, mp4, avi, mov, or mkv) pre-stored in the storage unit 175 of the portable apparatus 100 or pre-stored in and received from the outside of the portable apparatus 100 using a video codec unit (not illustrated) under control of the controller 110. Most of applications installable in the portable apparatus 100 may reproduce audio and moving images using the audio codec unit and the video codec unit.

When a plurality of video sources corresponding to a plurality of applications according to the exemplary embodiment of the present general inventive concept, are output through one video codec unit, the controller 110 inputs the plurality of video sources to the video codec unit through an integrated interchip sound (I2S) port (not illustrated). The video codec unit may output the plurality of input video sources through the first touch screen 190a located in the first housing 100a, and the second touch screen 190b located in the second housing 100b.

When the plurality of video sources corresponding to the plurality of applications according to the exemplary embodiment of the present general inventive concept, are output through a plurality of video codec units, the controller 110 inputs a first video source to a first video codec unit through an I2S port, and input a second video source to a second video codec unit through the I2S port. The controller 110 may process the input first video source using the first video codec unit and output the processed result through the first touch screen 190a located in the first housing 100a. The controller 110 may process the input second video source using the second video codec unit and output the processed result through the second touch screen 190b located in the second housing 100b.

When a 5.1 channel sound source according to an exemplary embodiment of the present general inventive concept is output through one audio codec unit, the controller 110 inputs the sound source the audio codec unit through an I2S port. The audio codec unit may output to the input sound source through the speakers 163a, 163b, and 163e located in the first housing 100a, and the speakers 163c, 163d, and 163f located in the second housing 100b. The directional speakers 163a to 163f located in the portable apparatus 100 may provide the user a divided sound source to corresponding directions without interference.

Further, when the 5.1 channel sound source according to an exemplary embodiment of the present general inventive concept is output through a plurality of audio codec units, the controller 110 may divide the sound source into two channels of a primary sound source and a secondary sound source, and input the divided sound sources to two audio codec units through an I2S port. The first audio codec unit may output the input primary sound source for example through the speakers 163a, 163b, and 163e located in the first housing 100a. The secondary audio codec unit may output the input secondary sound source for example through the speakers 163c, 163d, and 163f located in the second housing 100b. The directional speakers 163a to 163f located in the portable apparatus 100 may provide the user the divided sound sources to corresponding directions without interference.

Production and sale of many kinds of video and audio codec units will be easily understood by the person having ordinary skill in the art. Further, the moving image reproduction unit 143 may reproduce a sound source using a video codec unit or an audio codec unit.

The multimedia unit 140 may include the audio reproduction unit 142 and the moving image reproduction unit 143 other than the broadcasting communication unit 141. Further, the audio reproduction unit 142 or the moving image reproduction unit 143 of the multimedia unit 140 may be included in the controller 110. In exemplary embodiments of the present general inventive concept, the term “video codec unit” includes one or a plurality of video codec units. In exemplary embodiments of the present general inventive concept, the term “audio codec unit” includes one or a plurality of audio codec units.

The camera unit 150 may include at least one of the first camera 151 of the first housing 100a and the second camera 152 of the second housing 100b, configured to shoot a still image or a moving image under control of the controller 110. The camera unit 150 may include one of the first camera 151 and the second camera 152 or both the first and second cameras 151 and 152. Further, the first camera 151 or the second camera 152 may include an auxiliary light source (for example, a flash (not illustrated)) configured to provide an amount of light required to shoot.

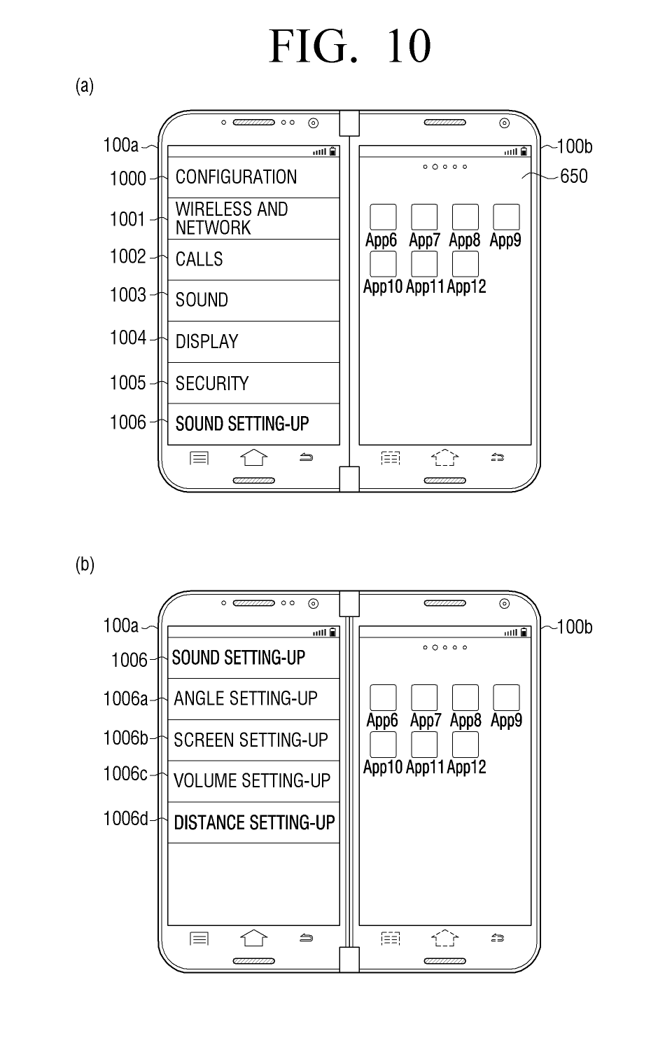

Alternatively, under control of the controller 110, the first camera 151 and the second camera 152 may be located adjacent to each other (for example, in the unfolded state as illustrated in FIG. 1A or in a state as illustrated in FIG. 10A to be described later, the distance between the first camera 151 and the second camera 152 is in a range of 2 cm to 8 cm), and the first camera 151 and the second camera 152 shoot a three-dimensional (3D) still image or a 3D moving image. When the distance between the first camera 151 and the second camera 152 is smaller than a lateral length of the first housing 100a (for example, perpendicular to the distance D1), the first and second cameras 151 and 152 may be located only in the first housing 100a or only in the second housing 100b. When the distance between the first camera 151 and the second camera 152 is larger than the lateral length of the first housing 100a (for example, perpendicular to the distance D1), the first and second cameras 151 and 152 may be located in the first housing 100a and the second housing 100b, respectively.

The GPS unit 155 receives radio waves from a plurality of GPS satellites (not illustrated) on the earth's orbit. The portable apparatus 100 may calculate a location of the portable apparatus 100 using “time of arrival” of the waves from the GPS satellites to the GPS unit 155.

The input/output unit 160 may include at least one of the plurality of buttons 161, the mike 162, the speaker 163, the vibration motor 164, the connector 165, the key pad 166, and the input unit 167.

The buttons 161 may include the first button group 161a in a lower portion of a front side of the first housing 100a, the second button group 161b in a lower portion of a front side of the second housing 100b, and the power/lock button (not illustrated) and at least one volume button (not illustrated) in a side 100f of the first housing 100a or the second housing 100b. This configuration is illustrated for example in FIG. 1A.

The first button group 161a is located in the lower portion of the front side of the first housing 100a, and includes a menu button 161a1, a home button 162a2, and a back button 161a3. The second button group 161b is located in the lower portion of the front side of the second housing 100b, and includes a menu button 161b1, a home button 161b2, and a back button 161b3. Further, the first button group 161a may include only the home button 161a2. Similarly, the second button group 161b may include only the home button 161b2. Further, the buttons of the first button group 161a and the buttons of the second button group 161b may be implemented not with physical buttons, but with touch buttons. Alternatively, the portable apparatus 100 may include only the buttons 161a1 to 161a3 of the first button group 161a. The buttons 161a1 to 161a3 of the first button group 161a may be implemented with touch buttons.

The mike 162 receives voice or sound from the outside to generate an electrical signal under control of the controller 110. The electrical signal generated in the mike 162 is converted in an audio codec unit and stored in the storage unit 175 or output through the speaker 163. One or a plurality of mikes 162 may be located in the housings 100a and 100b of the portable apparatus 100. For example, at least one mike 162 may be located only in the first housing 100a or only in the second housing 100b or the at least one mike 162 may be located in both the first and second housings 100a and 100b.

The speaker 163 may output sounds corresponding to various signals (for example, a radio signal, a broadcast signal, a sound source, a moving image file, a photographing result, or the like) of the mobile communication unit 120, the sub communication unit 130, the multimedia unit 140, or the camera unit 150 to the outside of the portable apparatus 100 using an audio codec unit under control of the controller 110.

The speaker 163 may output sounds (for example, a button operating tone or a ring back tone corresponding to phone calls) corresponding to functions performed by the portable apparatus 100. At least one speaker 163 may be located in an appropriate location or plurality of locations of the housings 100a and 100b. For example, as illustrated in FIGS. 1A and 1B, the plurality of speakers 163a to 163f are located in the front sides and the back sides of the first housing 100a and the second housing 100b.

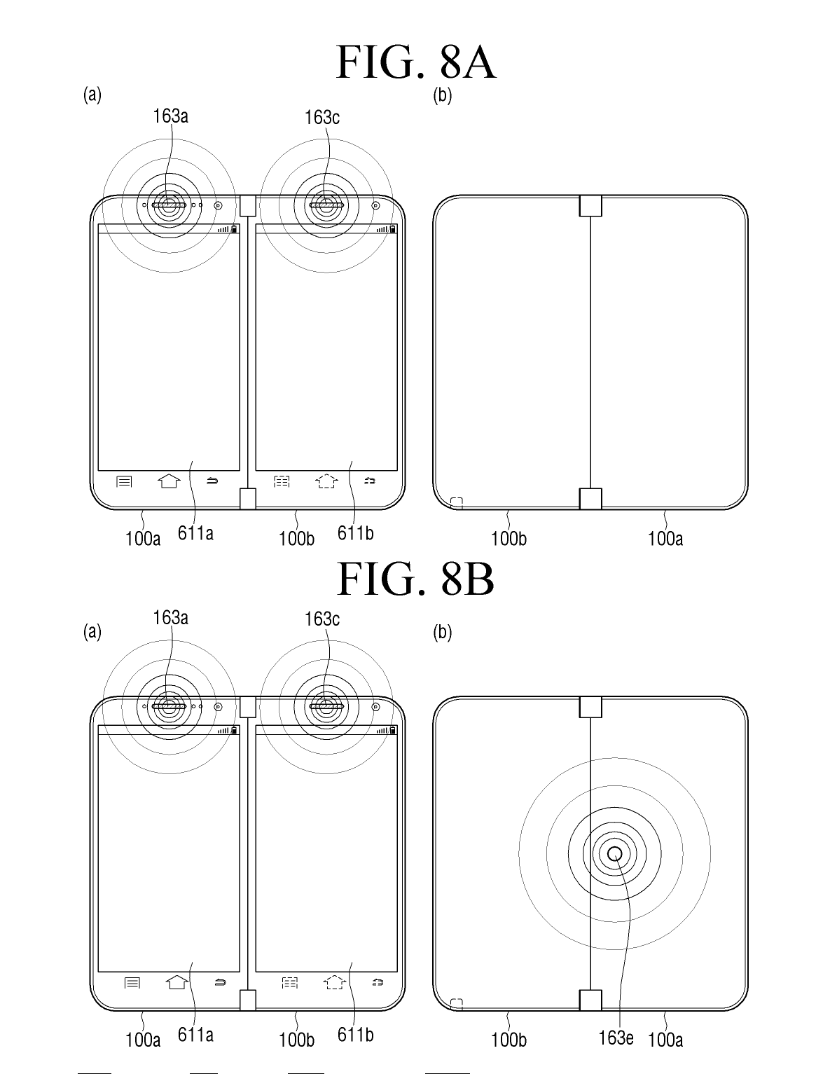

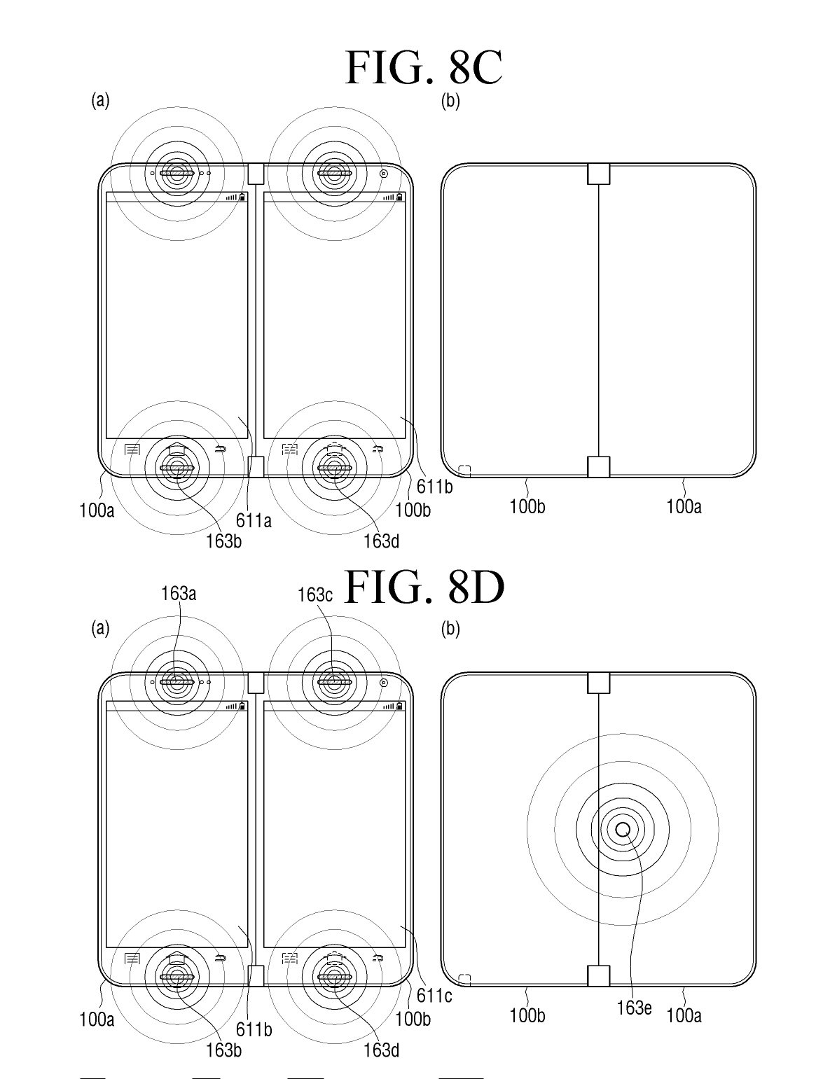

As illustrated in view (a) of FIG. 8A, to be described later, one speaker 163a and 163c may be located only in the front side of each of the housings 100a and 100b. Alternatively, as illustrated in views (c) and (d) of FIG. 8A, to be described later, one speaker 163a and 163c may be located in the front side of each of the housings 100a and 100b, and one speaker 163e may be located in the back sides of any one of the housings 100a and 100b.

The speaker 163 may be located in at least one of four sides (for example, the four sides of an upper side, a lower side, a left side, and a right side) of each of the housings 100a and 100b connecting the front sides and the back sides of the housings 100a and 100b. The portable apparatus 100, in which the speakers are located in the front sides, the sides, and the back sides of the housings 100a and 100b, may provide sound output effects different from a portable apparatus 100 in which the speakers 163 are located in the front sides and the back sides of the housings 100a and 100b.

Among the speakers 163, a plurality of speakers 163a, 163b, and 163e located in the first housing 100a are referred to a first speaker group, and a plurality of speakers 163c, 163d, and 163f located in the second housing 100b is referred to as a second speaker group.

In an exemplary embodiment of the present general inventive concept, sounds may be output through the speaker 163, that is, through a plurality of speakers 163 according to an output mode predetermined based on an angle between the first touch screen 190a and the second touch screen 190b and attributes of a plurality of executed applications. Further, the output mode of the speaker 163 includes at least one of on/off of sound output and volume adjustment for each of the plurality of speakers 163.

The vibration motor 164 may convert an electrical signal into a mechanical vibration under control of the controller 110. For example, when request for voice calls is received from other portable apparatus (not illustrated), the vibration motor 164 in the portable apparatus 100, which is in a vibration mode, operates. One or a plurality of vibration motors 164 may be located in the housings 100a and 100b of the portable apparatus 100. For example, at least one vibration motor 164 is located only in the first housing 100a or only in the second housing 100b, or the at least one vibration motor 164 may be located in each of the first and second housings 100a and 100b. The vibration motor 164 may allow each of the housings 100a and 100b to vibrate wholly or partially.

The vibration motor 164 according to the exemplary embodiment of the present general inventive concept may provide haptic feedbacks corresponding to sounds output from a plurality of speakers according to an output mode predetermined based on an angle between the first touch screen 190a and the second touch screen 190b and attributes of a plurality of executed applications. Haptic feedbacks denote nonverbal communication, such as vibration.

The vibration motor 164 may provide a variety of haptic feedbacks (for example, strength of the vibration and vibration duration) according to pitches, dynamics, and tones of the sounds output in the speakers by the controller 110.

The connector 165 may be used as an interface configured to connect the portable apparatus 100 and an external apparatus (not illustrated), or between the portable apparatus 100 and an external power source (not illustrated). Under control of the controller 110, data stored in the storage unit 175 of the portable apparatus 100 may be transmitted the external apparatus or data may be received from the external apparatus, through a wired cable (not illustrated) connected to the connector 165. Power is provided from the power source or a battery (not illustrated) of the power supply unit 180 is charged by power from the external power source provided through the wired cable connected to the connector 165.

The key pad 166 may receive a key input to control the portable apparatus 100 from the user. The key pad 166 may include a physical key pad (not illustrated) formed in the portable apparatus 100 or virtual key pads (not illustrated) displayed in the touch screens 190a and 190b. The physical key pad formed in the portable apparatus 100 may be omitted according to the performance or a structure of the portable apparatus 100.

The input unit 167 may interact with menus or icons displayed in the touch screens 190a and 190b of the portable apparatus 100 or input characters, figures, or the like. For example, the input unit 167 may touch a capacitive touch screen (not illustrated), a resistive touch screen (not illustrated), or electromagnetic induction type touch screen (not illustrated), or input characters, and the like. For example, the input unit 167 may include a stylus or a haptic pen (not illustrated), and the like in which an embedded actuator (not illustrated) is vibrated using a command received from the short range communication unit 132 of the portable apparatus 100. The actuator may be vibrated using sensing information detected in a sensor (not illustrated) embedded in the haptic pen other than the command received from the portable apparatus 100.

The sensor unit 170 includes at least one sensor configured to detect a status of the portable apparatus 100. For example, the sensor unit 170 may include the proximity sensor 171 located in an upper portion of a front side of the portable apparatus 100 and configured to detect an object approaching to the portable apparatus 100, an angle sensor 172 configured to detect an angle formed between the first housing 100a and the second housing 100b, an illuminance sensor (not illustrated) configured to detect an amount of light around the portable apparatus 100, an acceleration sensor (not illustrated) configured to detect a tilt of three axes (for example, an x-axis, a y-axis, and a z-axis) applied to the portable apparatus 100, a gyro sensor (not illustrated) configured to detect a direction using rotational inertia of the portable apparatus 100, a gravity sensor (not illustrated) configured to detect a direction of the gravity, or an altimeter (not illustrated) configured to an attitude by measuring atmospheric pressure. The sensor unit 170 may detect kinetic acceleration and gravitational acceleration-added acceleration of the portable apparatus. When the portable apparatus 100 does not move, the sensor unit 170 may detect only gravitational acceleration. For example, the gravitational acceleration is a positive (+) direction when the front side of the portable apparatus 100 is up, and the gravitational acceleration is a negative (−) direction when the front side of the portable apparatus 100 is down.

The angle sensor 172 is located in the hinges 100c1, 100c2, and 100c3 of the portable apparatus 100, detects an angle formed between the first housing 100a and the second housing 100b, and transmits angle information corresponding to the detected angle to the controller 110. The angle sensor 172 may measure the angle in a range of 0 (zero) degree to 360 degrees. Further, the angle sensor 172 may be implemented with a geometric sensor (not illustrated) or a gyro sensor. The angle sensor 172 may include a hinge type angle sensor (not illustrated) rotated by the angle formed between the first housing 100a and the second housing 100b. The angle sensor 172 may measure the angle between the first touch screen 190a and the second touch screen 190b located in one flexible housing (not illustrated). For example, if the housing is a flexible housing, the angle may be measured using a bending sensor (not illustrated) or a pressure sensor (not illustrated).

Here, separate sensors may be located in a plurality of housings 100a and 100b to measure gravitational accelerations of the housings. For example, when the portable apparatus 100 comes in contact with a flat surface, the gravitational acceleration of the first housing 100a is positive (+), and the gravitational acceleration of the second housing 100b is positive (+), the angle between the first housing 100a and the second housing 100b is about 180 degrees. When the portable apparatus 100 comes in contact with a flat surface, the gravitational acceleration of the first housing 100a is positive (+), and the gravitational acceleration of the second housing 100b is negative (−), the angle between the first housing 100a and the second housing 100b is zero degree or 360 degrees. Further, the accurate angle between the first housing 100a and the second housing 100b may be measured using a plurality of sensors (for example, an acceleration sensor and angle sensor 172).

At least one sensor included in the sensor unit 170 detects a status of the portable apparatus 100, generates a signal corresponding to the detected status, and transmits the generated signal to the controller 110. The sensors of the sensor unit 170 may be added or deleted according to the performance of the portable apparatus 100.

The storage unit 175 may store signals or data input/output according to operations of the mobile communication unit 120, the sub communication unit 130, the multimedia unit 140, the camera unit 150, the GPS unit 155, the input/output unit 160, the sensor unit 170, the first touch screen 190a, or the second touch screen 190b under control of the controller 110. The storage unit 175 may store control programs to control the portable apparatus 100 or the controller 110, graphic user interfaces (GUIs) related to applications provided by a manufacturer or downloaded from the outside, images to provide the GUIs, user information, documents, data bases, or related data. The storage unit 175 according to an exemplary embodiment of the present general inventive concept may store the angle between the housings 100a and 100b, attributes of applications, a variety of haptic feedbacks corresponding to the output modes for sound output in speakers and the sound output.

The term “storage unit” in the exemplary embodiment of the present general inventive concept may include the storage unit 175, the ROM 112 or the RAM 113 in the controller 110, or a memory card (not illustrated) (for example, a secure digital (SD) card or a memory stick) mounted on the portable apparatus 100. The storage unit may include a nonvolatile memory, a volatile memory, a hard disc drive (HDD), or a solid state drive (SSD).

The power supply unit 180 may supply power to one or a plurality of batteries (not illustrated) located in the housings 100a and 100b under control of the controller 110. The one or the plurality of batteries are located between each of the touch screens 190a and 190b, and the opposite side of each of the housings 100a and 100b. In the current exemplary embodiment of the present general inventive concept, the touch screens 190a and 190b are located in the front sides of the housings 100a and 100b, therefore the opposite side of each of the housings 100a and 100b is the back side of the corresponding housings. Further, the power supply unit 180 may supply power provided from an external power source (not illustrated) to the portable apparatus 100 through a wired cable (not illustrated) connected to the connector 165.

The touch screens 190a and 190b may provide the user GUIs corresponding to a variety of services (for example, calls, data transmission, broadcasting, photographing, a moving image, or an application). The touch screens 190a and 190b transmit analog signals corresponding to one or a plurality of touches input through the GUIs to touch screen controllers 195, 195a of FIGS. 4, and 195b of FIG. 4. The touch screens 190a and 190b may receive the one or the plurality of touches through the user's body (for example, fingers including a thumb) or a touchable object (for example, the input unit 167).

The touch in the exemplary embodiment of the present general inventive concept is not limited to the user's touch with the touch screens 190a and 190b or the touch with the touchable object, and the touch may include non-touch (for example, a detectable distance between each of the touch screens 190a and 190b and the user's body or between each of the touch screens 190a and 190b and touchable object is 3 mm or less). The non-touch distance detectable in the touch screens 190a and 190b may be changed according to the performance or a structure of the portable apparatus 100.

For example, the touch screens 190a and 190b may be implemented with a resistive type, a capacitive type, an infrared type, or an acoustic wave type touch screen.

The touch screen controller 195 may convert analog signals corresponding to one or a plurality of touches received from the touch screens 190a and 190b into digital signals (for example, X and Y coordinates corresponding to the touch locations), and transmit the converted digital signals to the controller 110. The controller 110 may control the touch screens 190a and 190b using the digital signals received from the touch screen controller 195. For example, the controller 110 may display selection of a shortcut (not illustrated) displayed in the touch screens 190a and 190b or execute an application corresponding to the selected shortcut (not illustrated) in response to the input touch. Further, the controller 110 may calculate X and Y coordinates corresponding to the touch locations using the digital signals received from the touch screen controller 195. In some exemplary embodiments of the present general inventive concept, one touch screen controller 195 controls one touch screen 190a or a plurality of touch screens 190a and 190b. Further, a plurality of touch screen controllers 195 may control one touch screen 190a. The touch screen controller 195 may be included in the controller 110 according to the performance or a structure of the portable apparatus 100.

In exemplary embodiments of the present general inventive concept, the term “touch screen controller” includes the touch screen controller 195 illustrated in FIG. 3, as well as a plurality of touch screen controllers in the same portable apparatus 100. An example of such a plurality of touch screen controllers 195 is illustrated in FIG. 4, which illustrates a first touch screen controller 195a and a second touch screen controller 195b.

FIG. 4 is a schematic block diagram illustrating a portable apparatus 100 according to another exemplary embodiment of the present general inventive concept.

Referring to FIG. 4, among components of the portable apparatus 100, the remaining components other than the first controller 110a, the second controller 100b, the first touch screen controller 195a, and the second first touch screen controller 195b are substantially the same as those of FIG. 3, and thus repeated description thereof will be omitted.

The first controller 110a may include a first AP 111a, a first ROM 112a configured to store a control program to control the portable apparatus 100, and a first RAM 113a configured to store a signal or data input from the outside of the portable apparatus 100 or to be used as a storage region for a job performed in the portable apparatus 100. The first AP 111a, the first ROM 112a, and the first RAM 113a may be mutually connected through a first internal bus 114a.

The first controller 110a may control a mobile communication unit 120, a sub communication unit 130, a multimedia unit 140, a camera unit 150, a GPS unit 155, an input/output unit 160, a sensor unit 170, a storage unit 175, a power supply unit 180, the first touch screen 190a, and the first touch screen controller 195a.

The first touch screen controller 195a may convert analog signals corresponding to one or a plurality of touches received from the first touch screen 190a into digital signals (for example, X and Y coordinates), and transmit the converted digital signals to the first controller 110a. The first controller 110a may control the first touch screen 190a using the digital signals received from the first touch screen controller 195a. The first touch screen controller 195a may be included in the first controller 110a.

The second controller 110b may include a second AP 111b, a second ROM 112b configured to store a control program to control the portable apparatus 100, and a second RAM 113b configured to store a signal or data input from the outside of the portable apparatus 100 or to be used as a storage region for a job performed in the portable apparatus 100. The second AP 111b, the second ROM 112b, and the second RAM 113b may be mutually connected through a second internal bus 114b.

The second controller 110b may control the mobile communication unit 120, the sub communication unit 130, the multimedia unit 140, the camera unit 150, the GPS unit 155, the input/output unit 160, the sensor unit 170, the storage unit 175, the power supply unit 180, the second touch screen 190b, and the second touch screen controller 195b.

The second touch screen controller 195b may convert analog signals corresponding to one or a plurality of touches received from the second touch screen 190b into digital signals (for example, X and Y coordinates), and transmit the converted digital signals to the second controller 110b. The second controller 110b may control the second touch screen 190b using the digital signals received from the second touch screen controller 195b. The second touch screen controller 195b may be included in the second controller 110b.

In an exemplary embodiment of the present general inventive concept, the first controller 110a may control at least one component, which may disposed in the first housing 100a in which the first controller 100a is located, for example, the first touch screen 190a, the first touch screen controller 195a, the mobile communication unit 120, the sub communication unit 130, the multimedia unit 140, the first camera 151, the GPS unit 155, the first button group 161a, a power/lock button (not illustrated), at least one volume button (not illustrated), the sensor unit 170, the storage unit 175, and the power supply unit 180.

The second controller 110b may control at least one component, which may disposed in the second housing 100b in which the second controller 100b is located, for example, the second touch screen 190b, the second touch screen controller 195b, the second camera 152, the second button group 161b, the storage unit 175, and the power supply unit 180.

In another exemplary embodiment of the present general inventive concept, the first controller 110a and the second controller 110b may separately control different components of the portable apparatus 100. For example, the first controller 110a may control the mobile communication unit 120, the sub communication unit 130, and the input/output unit 160, and the second controller 110b may control the multimedia unit 140, the camera unit 150, the GPS unit 155, and the sensor unit 170. Alternatively, the first controller 110a and the second controller 110b may control the components of the portable apparatus 100 according to a priority, that is, the mobile communication unit 120 has the top priority in the first controller 110a, and the multimedia unit 140 has the top priority in the second controller 110b. The first controller 110a and the second controller 110b are separately located in the first housing 100a and the second housing 100b, respectively, or the first controller 110a and the second controller 110b may be located only in the first housing 100a. Further, the first controller 110a and the second controller 110b may be implemented with one controller 110 including an AP having a plurality of cores (not illustrated) such as dual cores.

Referring to views (a) and (b) of FIG. 10, the control priority of the controller 110 may be changed (for example, the priority of the first controller 110a is the mobile communication unit 120) in a controller priority item (not illustrated) of a configuration 1000.

Referring to FIGS. 1 to 4, the first touch screen 190a is located in the first housing 100a, and the second touch screen 190b is located in the second housing 100b. However, both the first touch screen 190a and the second touch screen 190b may be located in one housing (not illustrated). In the one housing, a gap may be formed between the first touch screen 190a and the second touch screen 190b to detect an angle between the first touch screen 190a and the second touch screen 190b.

The one housing may include a flexible housing (not illustrated) which may be easily bent. Further, the flexible housing may include a flexible display (not illustrated). The flexible housing or the flexible display may include all or portions of the plurality of components 110 to 195 illustrated in FIGS. 3 and 4. The components of the flexible display may be substantially the same as those of the portable apparatus 100, and thus repeated description thereof will be omitted.

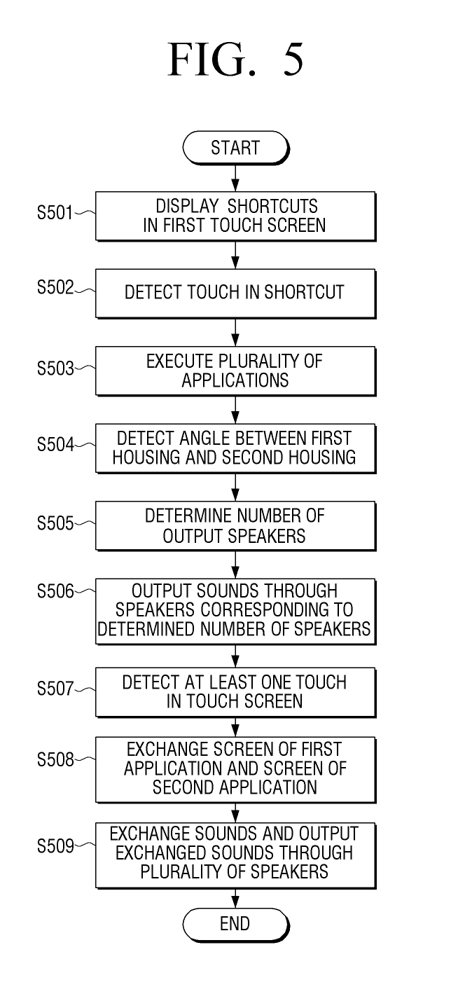

FIG. 5 is a schematic flowchart illustrating a sound output method of a portable apparatus 100 according to an exemplary embodiment of the present general inventive concept.

FIGS. 6A and 6B are views illustrating an example of a sound output method of a portable apparatus 100 according to a first exemplary embodiment of the present general inventive concept.

In operation S501 of FIG. 5, one or a plurality of shortcuts are displayed in a first touch screen 190a of a first housing 100a.

Referring to view (a) of FIG. 6A, a first screen 600 is displayed in a first touch screen 190a. The first screen 600 includes a first status bar 601 and a first shortcut display region 602. The first status bar 601 displays a status of a portable apparatus 100 such as a charging state 601a of a battery, intensity of a reception signal 601b of a portable phone, or a vibration mode icon (not illustrated). The first status bar 601 may display an icon indicating operation statuses of a plurality of touch screens 190a and 190b of the portable apparatus 100, such as a dual mode icon (not illustrated). Further, the dual mode icon may be also implemented with text. Shortcuts corresponding to at least one application, which may be executable in the portable apparatus 100, are displayed in the first shortcut display region 602. In the exemplary embodiment of the present general inventive concept illustrated in view (a) of FIG. 6A, a plurality of application shortcuts, represented by App1 to App5, are displayed on the first shortcut display region 602.

The first status bar 601 may not be displayed in the first screen 600 of the portable apparatus 100 according to operating system (OS) or an application. When the first status bar 601 is not displayed, only the first screen 600 may be displayed in the first touch screen 190a. For example, the application of the portable apparatus 600 may include a messenger application, a web browser, a moving image player, an audio player, or a social network service (hereinafter, referred to as “SNS”) application. The application executable in the portable apparatus 100 may include an application and a widget downloaded from an online market or provided from a manufacturer or a communication service provider.

A screen of a messenger application (a friend list or a time line) displayed in the touch screen 190a or 190b is larger than a lateral length or a vertical length of each of the touch screens 190a and 190b, the screen of the messenger application may be provided as a plurality of screens. For example, a total length of a web page currently displayed in a web browser is larger than the lateral length or the vertical length of each of the touch screens 190a and 190b, the displayed web page is divided according to the lateral length or the vertical length of each of the touch screens 190a and 190b, and only portions of the divided screens may be displayed, and for example, the remaining portions may be displayed by scrolling. Even when the screen of an SNS application (for example, a time line) is larger than the lateral length or the vertical length of each of the touch screens 190a and 190b, the screen may be substantially displayed the same as described above.

The examples of the applications providing the plurality of screens will be easily understood by the person having ordinary skill in the art.

A second screen 650 is displayed in the second touch screen 190b. The second screen 650 displays a second status bar 651 configured to display a status of the portable apparatus 100, and a second shortcut display region 652 in which one or more shortcuts (illustrated in view (a) of FIG. 6A as a plurality of shortcuts App6 to App12 consecutive to the shortcuts displayed in the first shortcut display region 602 of the first screen 600), are displayed. The second screen 650 is substantially the same as the first screen 600, and thus repeated description thereof may be omitted.

In operation S502 of FIG. 5, a touch 605 is detected in at least one of the shortcuts.

Referring to view (a) of FIG. 6A, a first shortcut 602a displayed in the first touch screen 190a is touched (for example, tapped as indicated by touch 605a) by the user. The controller 110 detects the user touch 605a on the first touch screen 190a through the first touch screen 190a and the touch screen controller 195. Further, referring to view (a) of FIG. 6B, a second shortcut 602b displayed in the first touch screen 190a is touched (for example, tapped as indicated by touch 605b) by the user. The controller 110 detects the user touch 605b on the first touch screen 190a through the first touch screen 190a and the touch screen controller 195. The controller 110 receives location information (for example, X1 and Y1 coordinates corresponding to the touch 605a, and X2 and Y2 coordinates corresponding to the touch 605b) corresponding to the touches 605a and 605b from the touch screen controller 195.

The controller 110 may store locations of touches 605a and 605b on the first touch screen 190a, which are included in the received location information, touch detection times (for example, 10:05 a.m.) of the detected touches 605a and 605b, and touch information corresponding to the touches 605a and 605b in the storage unit 175. The touches 605a and 605b touched in the first touch screen 190a may be generated, for example, by one of fingers including a thumb (not illustrated) or the touchable input unit 167.

A change in the number of detected touches 605 according to the performance or a structure of the portable apparatus 100 will be easily understood by the person having ordinary skill in the art.

In operation S503 of FIG. 5, a plurality of applications are executed.

Referring to view (b) of FIG. 6A, the controller 110 executes an application (for example, a movie player 610a) corresponding to the touch 605a of the first shortcut 602a. The controller 110 displays the movie player 610a, not in the first touch screen 190a to which the touch 605a is input, but in the second touch screen 190b. Alternatively, the controller 110 may display the movie player 610a in the first touch screen 190a to which the touch 605a is input. One or a plurality of reproducible movie files (not illustrated) may be displayed in a first screen (not illustrated) of the movie player 610a. The movie file may be displayed as a movie icon corresponding thereto.

When one of the movie files displayed in the first screen of the movie player 610a is touched by the user, the controller 110 may reproduce a movie (for example, as illustrated by 611a in view (b) of FIG. 6A) corresponding to the selected movie file in the movie player 610a.

The controller 110 detects the user touch 605 through the touch screen and the touch screen controller 195. The controller 110 receives location information (for example, X3 and Y3 coordinates) corresponding to the touch 605 from the touch screen controller 195. The controller 110 may execute the movie 611a using the location information (for example, the X3 and Y3 coordinates) corresponding to the touch 605.

The controller 110 may output a video source corresponding to the movie 611a using a video codec unit (not illustrated) through the movie player 610a. The controller 110 outputs a sound source corresponding to the movie 611a using an audio codec unit (not illustrated) through one or a plurality of speakers 163. Alternatively, the controller 110 may output the video source and the sound source corresponding to the movie 611a using the video codec unit through the movie player 610a and the speakers 163. In an exemplary embodiment of the present general inventive concept, extensions (for example, mpg, avi, mp4, mkv, and the like) executable in an application (for example, the movie player 610a) may be set to be executed in the movie player 610a. The movie player 610a may discriminate a variety of executable contents through the extensions. Extension information corresponding to the extensions executable in the application may be stored as an application or a separate file. The extension of contents (for example, a movie) means information to discriminate whether or not the extension is executed in an application in which the contents are executed. The extension information corresponding to the extensions of the contents may be stored in a separate file.

Referring to view (b) of FIG. 6B, the controller 110 executes an application (for example, a music player 610b) corresponding to the touch 605b on the second shortcut 602b. The controller 110 displays the music player 610b not in the second touch screen 190b in which the touch 605b is input or the movie player 610a is displayed, but in the first touch screen 190a to which the touch 605a is input. The controller 110 may alternatively display the music player 610b in the second touch screen 190b in which the movie player 610a is displayed. When the music player 610b is executed in the second touch screen 190b, the movie player 610a may be executed in a background. When executed in a background, only the sound of the movie 611a of the movie player 610a may be output through the speaker 163. One or a plurality of reproducible music files (not illustrated) are displayed in a first screen (not illustrated) of the music player 610b. The music files may be displayed as music icons corresponding thereto.

When a music file displayed in the first screen of the music player 610b is touched by the user, the controller 110 reproduces music (for example, as illustrated by 611b) corresponding to the selected music file in the music player 610b.

The controller 110 detects the user touch 605 (not illustrated) through the touch screen 190a or 190b and the touch screen controller 195. The controller 110 receives location information (for example, X4 and Y4 coordinates) corresponding to the touch from the touch screen controller 195. The controller 110 may execute the music 611b using the location information (the X4 and Y4 coordinates) corresponding to the touch 605.

The controller 110 outputs a sound source corresponding to the music 611b using an audio codec unit through one or a plurality of speakers 163. The controller 110 may output an image corresponding to the music 611b using a video codec unit through the movie player 610a. Alternatively, the controller 110 may output the image and the sound source corresponding to the music 611b using the video codec unit through the music player 610b and the speakers 163. In an exemplary embodiment of the present general inventive concept, extensions (for example, mp3, ogg, way, wma, and the like) executable in an application (for example, the music player 610b) may be set to be executed in the music player 610b. The music player 610b may discriminate a variety of executable contents through the extensions. Extension information corresponding to the extensions executable in the application may be stored as an application or a separate file. The extension of contents (for example, music) means information to discriminate whether or not the extension is executed in an application in which the contents are executed. The extension information corresponding to the extensions of the contents may be stored in a separate file.

The controller 110 may set an application screen executed according to a touch 605 of a shortcut displayed in the first touch screen 190a to be preferentially displayed in one of the first touch screen 190a and the second touch screen 190b through screen setting-up 1006b of the configuration 1000 (see views (a) and (b) of FIG. 10). The controller 110 may set an application screen executed according to a touch 605 of a shortcut displayed in the second touch screen 190b to be preferentially displayed in one of the first touch screen 190a and the second touch screen 190b through the screen setting-up 1006b of the configuration 1000 (see views (a) and (b) of FIG. 10)

When a plurality of applications are displayed in the touch screens 190a and 190b, that is, when the movie player 610a is displayed in the second touch screen 190b and the music player 610b is displayed in the first touch screen 190a, the controller 110 displays a switching icon 601c corresponding to mutual exchange of application screens in the first status bar 601 of the first screen 600 or the second status bar 651 of the second screen 650. The controller 110 may display the switching icon 601c in both the status bars 601 and 651. The switching icon 601c will be described with reference to FIG. 6F.

In an operating system (OS) of an Android portable apparatus 100, the controller 110 may see attributes of applications using information stored in “androidmanifest.xml” stored in the storage unit. For example, the controller 110 may see information such as a name of an application, a library used in the application, an Android version, an application permission, a resolution supported in the application, and application components (for example, including activity and service).

The change in files, in which the attributes of the applications are stored, according to the OS of the portable apparatus will be easily understood by the person having ordinary skill in the art.

In operation S504 of FIG. 5, an angle between the first housing 100a and the second housing 100b is detected.

The first housing 100a and the second housing 100b of the portable apparatus 100 may be rotated in a range of 0 (zero) degree to 360 degrees using the hinge 100c. The controller 110 detects the angle between the first housing 100a and the second housing 100b using the angle sensor 172. The detectable angle is in a range of 0 (zero) degree to 360 degrees. Referring to view (a) of FIG. 6A, the detected angle between the first housing 100a and the second housing 100b of the portable apparatus 100 is about 60 degrees (for example, including an error of ±2 degrees).

The controller 110 may manually detect the angle between the first housing 100a and the second housing 100b by a user input as well as automatically detect the angle using the sensor unit 170. For example, the user may input the angle through selection of objects (for example, icons or texts) corresponding to various angles of the portable apparatus 100, displayed in the touch screen. An object (not illustrated) corresponding to the folded state of the portable apparatus 100 means that the angle between the first housing 100a and the second housing 100b is about 0 (zero) degrees. An object (not illustrated) corresponding to the unfolded state of the portable apparatus 100 means that the angle between the first housing 100a and the second housing 100b is about 180 degrees. An object (not illustrated) corresponding to a triangular shape of the portable apparatus 100 such as a desk calendar means that the angle between the first housing 100a and the second housing 100b is about 60 degrees. An object (not illustrated) corresponding to a laptop computer-like shape of the portable apparatus 100 means that the angle between the first housing 100a and the second housing 100b is about 210 degrees.

The controller 110 may detect the angle between the first housing 100a and the second housing 100b of the portable apparatus 100 using an acceleration sensor (not illustrated). In the exemplary embodiment of the present general inventive concept, the term “detection of the angle” has the same meaning as “input of the angle”. The angle may be input by the sensor unit 170 (for example, the angle sensor 172 and the acceleration sensor) or by the user.

In an exemplary embodiment of the present general inventive concept, the performing of the detection of the angle between the first housing 100a and the second housing 100b in operations S501 to S504 will be easily understood by the person having ordinary skill in the art.

In operation S505 of FIG. 5, the number of output speakers 163 is determined.

The controller 110 determines the number of output speakers 163 which are to output sounds in contents (for example, the movie 611a and the music 611b) using a parameter corresponding to the number of output speakers 163. For example, the controller 110 may extract a channel number in a channel-configuration header of contents to determine the number of speakers 163. The determined number of speakers 163 is 1, 2, 3, 4, 5, 6, 8, or more. An output mode is determined according to the determined number of speakers 163. For example, the output mode may be one among 1 channel (for example, one speaker 163), 2 channels (for example, 2 speakers 163), 2.1 channels (for example, two speakers 163 and one woofer speaker (163e, illustrated in FIG. 6C)), 4 channels (for example, 4 speakers 163), 5.1 channels (for example, 4 speakers 163, one woofer 163e, and one center speaker (163f, illustrated in FIG. 6C)), 7 channels (for example, 6 speakers 163, one woofer 163e, and one center speaker 163f), and more channels (for example, 7 speakers 163 or more, one or a plurality of woofer speakers 163e, and one or a plurality of center speakers 163f). The channel means that signals corresponding to the number of speakers 163 which are different from each other are input from a sound source to the speaker 163, and the speakers 163 output sounds. Alternatively, the output mode may be at least one of on/off of the sounds and volume adjustment of each of the plurality of speakers 163. For example, the output mode of the sound may control only on/off of sound output of the plurality of speakers 163, control only volume adjustment of the plurality of speakers 163, and control on/off of sound output of a portion of the plurality of speakers 163 and volume adjustment of a portion of the plurality of speakers 163.

The controller 110 has seen the plurality of installed speakers 163. The controller 110 may see the number of installed speakers 163 with reference the configuration stored in the storage unit of the portable apparatus 100.

The controller 110 extracts the channel number corresponding to the movie 611a to determine the number of speakers 163. Sounds may be output through a plurality of speakers 163c, 163d, and 163f in the second housing 100b in which the movie 611a is reproduced. The channel number corresponding to the movie 611a may be the same as or different from the number of speakers 163 in the second housing 100b.

When the channel number corresponding to the movie 611a is larger than the number of speakers 163 in the second housing 100b, that is, when the channel number is 6 and the number of speakers 163 in the second housing is 3, the controller 110 may down-mix sounds of 5.1 channels into sounds of 2.1 channels through one or a plurality of audio codec units and output the down-mixed sounds. When the channel number corresponding to the movie 611a is smaller than the number of speakers 163 in the second housing 100b, that is, when the channel number is 2 and the number of speakers 163 in the second housing is 3, the controller 110 may output sounds of 2 channels through an audio codec unit.

The controller 110 extracts the channel number corresponding to the music 611b to determine the number of speakers 163. Sounds may be output through a plurality of speakers 163a, 163b, and 163e in the first housing 100a in which the music 611b is reproduced. The channel number corresponding to the music 611b may be the same as or different from the number of speakers 163 in the first housing 100a.

When the channel number corresponding to the music 611b is larger than the number of speakers 163 in the first housing 100a, that is, when the channel number is 6 and the number of speakers 163 in the first housing is 3, the controller 110 may down-mix sounds of 5.1 channels into sounds of 2.1 channels through one or a plurality of audio codec units and output the down-mixed sounds. When the channel number corresponding to the music 611b is smaller than the number of speakers 163 in the first housing 100a, that is, when the channel number is 2 and the number of speakers 163 in the first housing is 3, the controller 110 may output sounds of 2 channels through an audio codec unit.

The controller 110 may control the sounds to be output through the speakers 163 of the housings 100a and 100b using the number of speakers 163 installed in the portable apparatus 100 and the number of speakers 163 extracted from the contents. In an exemplary embodiment of the present general inventive concept, the performing of the determination of the number of speakers 163 in operations S501 to S504 will be easily understood by the person having ordinary skill in the art.

In operation S506 of FIG. 5, sounds are output through speakers 163 corresponding to the determined number of speakers 163.

Referring to views (a) and (b) of FIG. 6C, there are total six speakers 163 in the portable apparatus 100 according to the illustrated exemplary embodiment of the present general inventive concept. Specifically, the first speaker 163a is located in an upper portion of a front side of the first housing 100a, and the second speaker 163b is located in a lower portion of the front side thereof. A woofer speaker 163e is located in a central region of a back side of the first housing 100a. The third speaker 163c is located in an upper portion of a front side of the second housing 100b, and the fourth speaker 163d is located in a lower portion of the front side thereof. A center speaker 163f is located in a central region of a back side of the second housing 100b.

The controller 110 outputs videos, images, and sounds corresponding to the movie player 610a executed in the second touch screen 190b and the music player 610b executed in the first touch screen 190a using a video codec unit and an audio codec unit.

The controller 110 outputs an angle between the first housing 100a and the second housing 100b, and videos, images, and sounds corresponding to the movie player 610a executed in the second touch screen 190b and the music player 610b executed in the first touch screen 190a using a video codec unit and an audio codec unit.

The controller 110 may control the sound output of the 6 speakers 163a through 163f to be ON, or control the volume adjustment (turn up/down volume) according to status information (for example, battery low, during calls, and the like) of the portable apparatus 100 received from the sensor unit 170 or surrounding status information (for example, when noise measured using a mike 162 is higher than a preset level of 80 dB) of the portable apparatus 100.

The controller 110 may provide the user with haptic feedback using the vibration motor 164 in response to sound output of a plurality of speakers 163a through 163f. The controller 110 may provide the user the haptic feedback by variously controlling the vibration motor 164 (for example, controlling the strength of vibration and vibration duration) according to pitches, dynamics, and tones of sounds output through the speakers 163a through 163f. When the plurality of applications 610a and 610b are executed, the controller 110 may allow the vibration motor 164 to operate in response to the sounds output from one of the plurality of applications. The controller 110 may set to preferentially provide the haptic feedback according to the sound of the one of the first application and the second application through vibration setting-up (not illustrated) of the configuration 1000 (see views (a) and (b) of FIG. 10). The controller 110 may control the haptic feedback to be maintained until video output and sound output are completed.

The existence of supportable extensions of contents will be easily understood by the person having ordinary skill in the art.

The output mode of the sound may include at least one of on/off of sound output and volume adjustment of a plurality of speakers 163 located in the housings 100a and 100b. For example, the output mode of the sound may control only on/off of the sound output of the plurality of speakers 163, control only the volume adjustment of the plurality of speakers 163, and control on/off of the sound output of a portion of the plurality of speakers 163 and volume adjustment of a portion of the plurality of speakers 163. Further, the output mode may include an audio system configured of 1 channel, 2 channels, 2.1 channels, 4 channels, 5.1 channels, 7.1 channels, or more channels using the speakers 163.

In operation S507 of FIG. 5, at least one touch is detected in the touch screen 190a or 190b.

Referring to view (a) of FIG. 6D, the user touches (as indicated by 605c) the music player 610a of the first touch screen 190a. The controller 110 detects the user touch 605c on the first touch screen 190a through the first touch screen 190a and the touch screen controller 195. The controller 110 receives location information (for example, X5 and Y5 coordinates) corresponding to the touch 605c from the touch screen controller 195. The controller 110 may store the location information including the location of touch 605c in the first touch screen 190a and a touch time when the touch 605c is detected in the storage unit. The touch 605c contacted with the first touch screen 190a may be generated, for example, by one of fingers including a thumb or an input unit 167.

Further, the number of touches 605 detected in the first touch screen 190a is not limited to one, and two or more touches 605 (for example, a touch 605c and additional touches (not illustrated)) may be detected. When two or more touches 605 are detected in the first touch screen 190a, the controller 110 may location information including the two or more touch locations and a plurality of touch times when a plurality of touches 605 are detected in the storage unit. The number of detected touches 605 will be easily understood by the person having ordinary skill in the art.

The controller 110 may detect consecutive movement of a touch (for example, consecutive X and Y coordinates corresponding to the movement from the touch 605c to an arrival 606) from the touch 605c on the first touch screen 190a toward the second touch screen 190b. The controller 110 may store the consecutive movement of the detected touch 605c in the storage unit.

The consecutive movement of the touch 605 may include consecutive movement from the touch 605c on the first touch screen 190a toward the second touch screen 190b and consecutive movement from a touch 605 (not illustrated) on the second touch screen 190b toward the first touch screen 190a. The consecutive movement of the touch 605 means that the contact on the touch screen 190a or 190b is continuously maintained. The consecutive movement of the touch 605 is stopped by releasing the touch 605 after a given distance.

The consecutive movement of the touch 605 may include consecutive movement from the touch 605c on the first touch screen 190a toward the second touch screen 190b by a predetermined distance (for example, 10 mm or more. The consecutive movement of the touch 605 on the second touch screen 190b is substantially the same as the consecutive movement of the touch 605 on the first touch screen 190a, and thus repeated description thereof will be omitted. The change in the predetermined distance through distance setting-up 1006d of the screen setting-up 1000b of the configuration 1000 (see views (a) and (b) of FIG. 10) will be easily understood by the person having ordinary skill in the art.

The controller 110 detects the arrival 606 of the consecutive movement of the touch 605c toward the second touch screen 190b. The arrival of the consecutive movement means a final contact location in the first touch screen 190a. The arrival 606 of the consecutive movement may be the final contact location in a region within the predetermined distance (for example, within 10 mm) from a side of the first touch screen 190b toward the touch 605c. The controller 110 detects an arrival (not illustrated) of consecutive movement on the second touch screen 190b toward the first touch screen 190a. The arrival of the consecutive movement means a final contact location on the second touch screen 190b. The arrival (not illustrated) of the consecutive movement may be the final contact location of a region within the predetermined distance (for example, within 10 mm) from a side of the second touch screen 190b toward the touch 605 (not illustrated).

Referring to view (a) of FIG. 6D, the consecutive movement of the touch 605 from the first touch screen 190a toward the second touch screen 190b includes drag & drop, flick, or rotation among touch gestures.

In another exemplary embodiment of the present general inventive concept, referring to FIG. 6F, the switching icon 601c displayed in the first status bar 601 of the first touch screen 190a is touched by the user as indicated by touch 605e. The controller 110 detects the touch 605e corresponding to the switching icon 601c through the first touch screen 190a and the touch screen controller 195. The controller 110 receives location information (for example, X6 and Y6 coordinates) corresponding to the touch 605e from the touch screen and the touch screen controller 195. The controller 110 may store location information including a touch location on the first touch screen 190a and a touch time when the touch 605e is detected in the storage unit 175.

The controller 110 may provide the user haptic feedback using the vibration motor 164 in response to the arrival 606 of the consecutive movement from the touch 605. The controller 110 may provide the user the haptic feedback using the vibration motor 164 in response to the touch of the switching icon 601c.

The controller 110 may provide a variety of haptic feedbacks motor by controlling the vibration motor 164 (for example, change in strength of vibration and vibration duration) in response to the arrival 606 of the consecutive movement from the touch 605c or the touch of the switching icon 601c. The controller 110 may control the haptic feedback to be maintained from the touch 605c to the arrival 606 of the consecutive movement.

In operation S508 of FIG. 5, a screen of a first application and a screen of a second application are exchanged.

Referring to view (b) of FIGS. 6D and 6F, the controller 110 mutually exchanges a screen of the movie player 610a and a screen of the music player 610b in response to the consecutive movement of the touch 605c toward the second touch screen 190b or the touch of the switching icon 601c. The controller 110 control the screen of the movie player 610a, which has been displayed in the second touch screen 190b, to be displayed in the first touch screen 190a, and control the screen of the music player 610b, which has been displayed in the first touch screen 190a, to be displayed in the second touch screen 190b, using a video codec unit. The mutual exchange of the screens may be completed substantially within 100 msec according to the arrival 606 of the consecutive movement of the touch 605c.

When a plurality of video codec units are used, the controller 110 may exchange a video codec unit corresponding to the movie player 610a and a video codec unit corresponding to the music player 610b. For example, the controller 110 may control an image corresponding to music 611b to be outputted in the video codec unit corresponding to the movie player 610a. The controller 110 may control a video corresponding to a movie 611a in the video codec unit corresponding to the music player 610b.

The controller 110 may provide the user haptic feedback using the vibration motor 164 in response to the mutual exchange of the screens. The controller 110 may provide the haptic feedback by variously controlling the vibration motor (for example, change in strength of vibration and vibration duration) according to the mutual change of the screens. The controller 110 may control the haptic feedback to be maintained until the mutual exchange of the screens is completed.

In operation S509 of FIG. 5, sounds are exchanged and outputted through the plurality of speakers.

Referring to views (a) and (b) of FIG. 6E, the controller 110 may mutually exchange sound of the movie 611a and sound of the music 611b and output the exchanged sounds through the speakers 163 in response to the exchange of the screen of the movie player 610a and the screen of the music player 610b. The exchange of the sound output may be completed substantially within 100 msec according to the screen exchange.

When a plurality of audio codec units are used, the controller 110 may control the sound corresponding to the music 611b to be output in an audio codec unit corresponding to the movie player 610a through the speakers 163a, 163b, and 163e of the first housing 100a. The controller 110 may control the sound to be output corresponding to the movie 611a in an audio codec unit corresponding to the music player 610a through the speakers 163c, 163d, and 163f of the second housing 100b. The controller 110 may complete the screen exchange and the sound exchange substantially within 100 msec in response to the consecutive movement of the touch 605c toward the second touch screen 190b.

In operation S509 of FIG. 5, sounds are output in the plurality of speakers 163 in response to the sound exchange based on the mutual exchange of the screens. After operation S509, the sound output method of the portable apparatus 100 having a plurality of touch screens 190 is terminated.

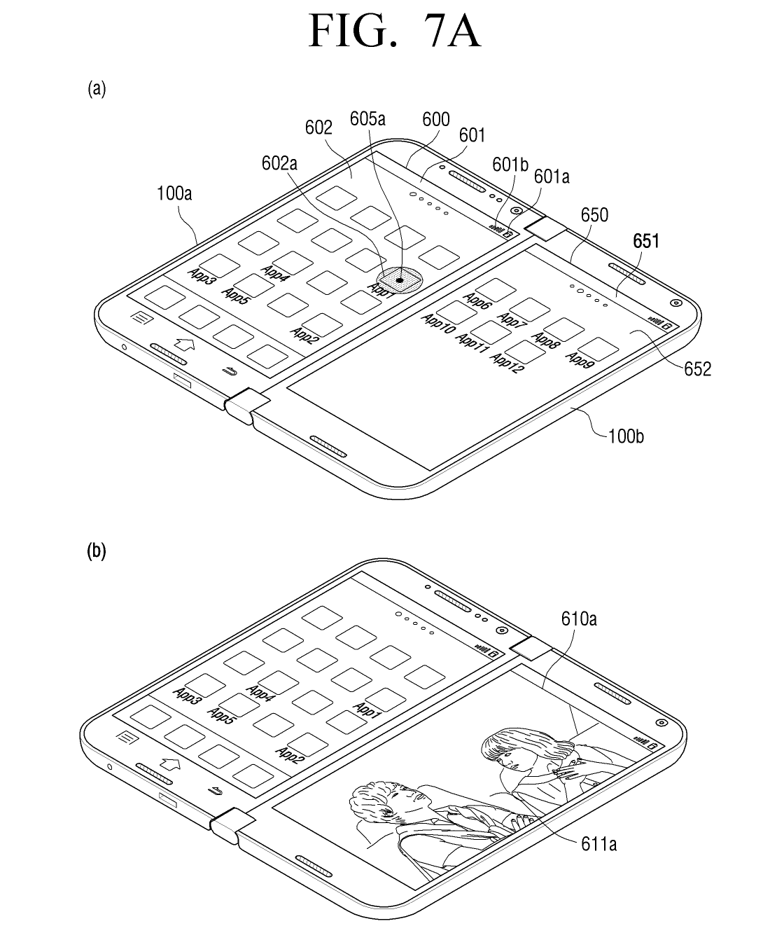

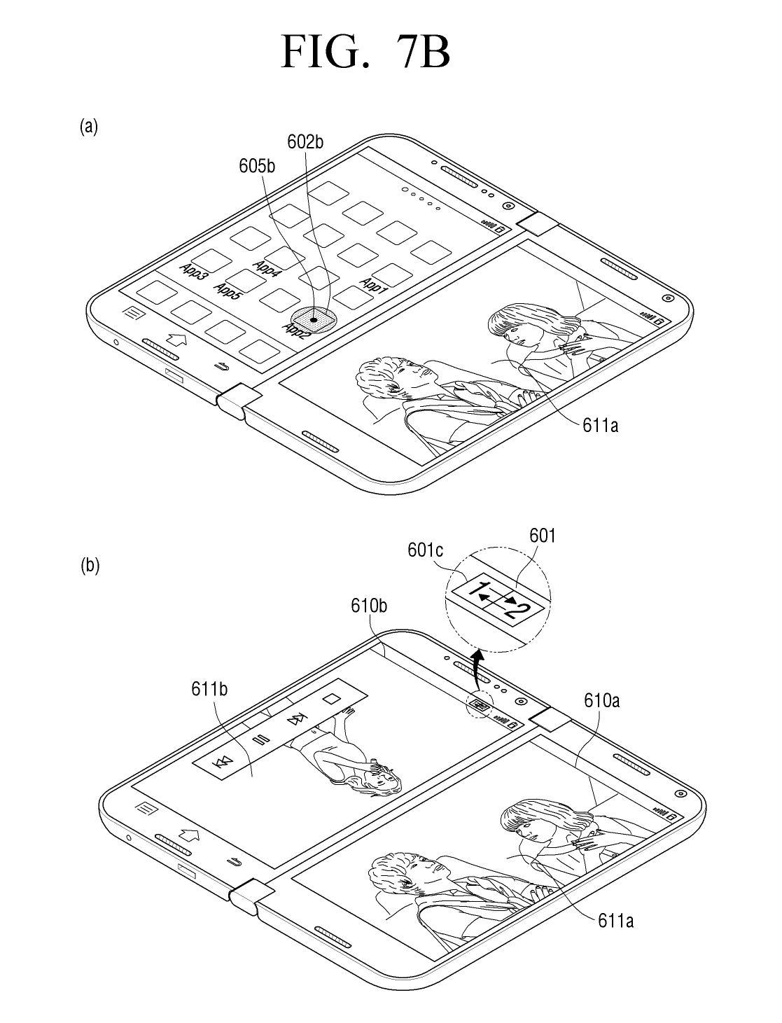

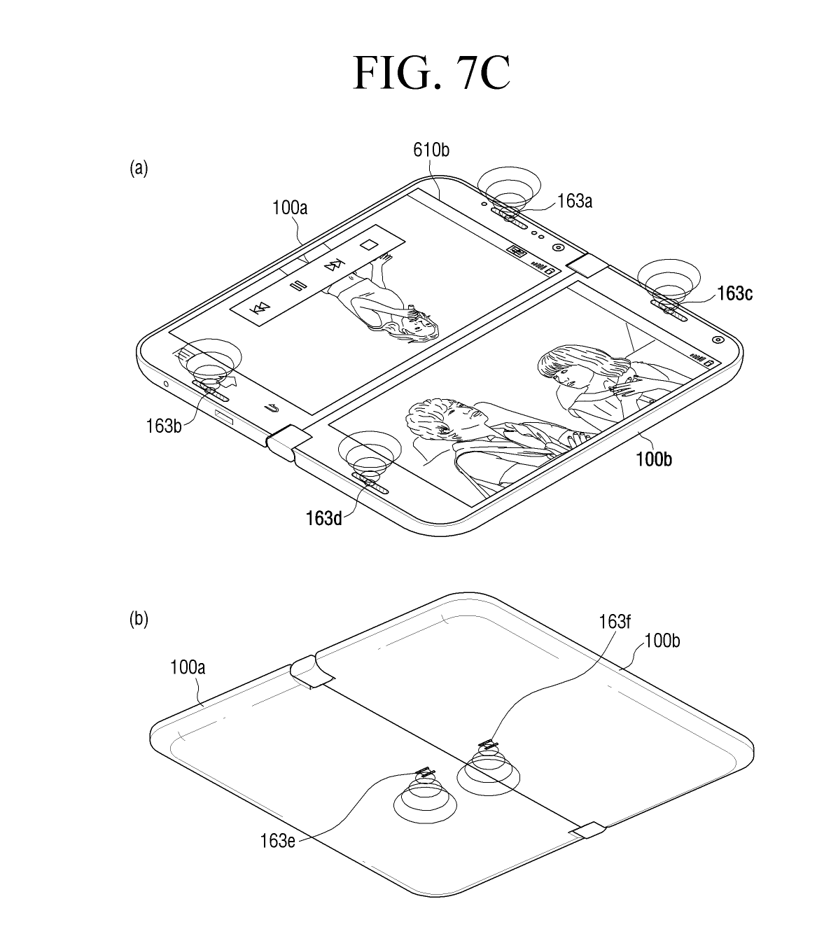

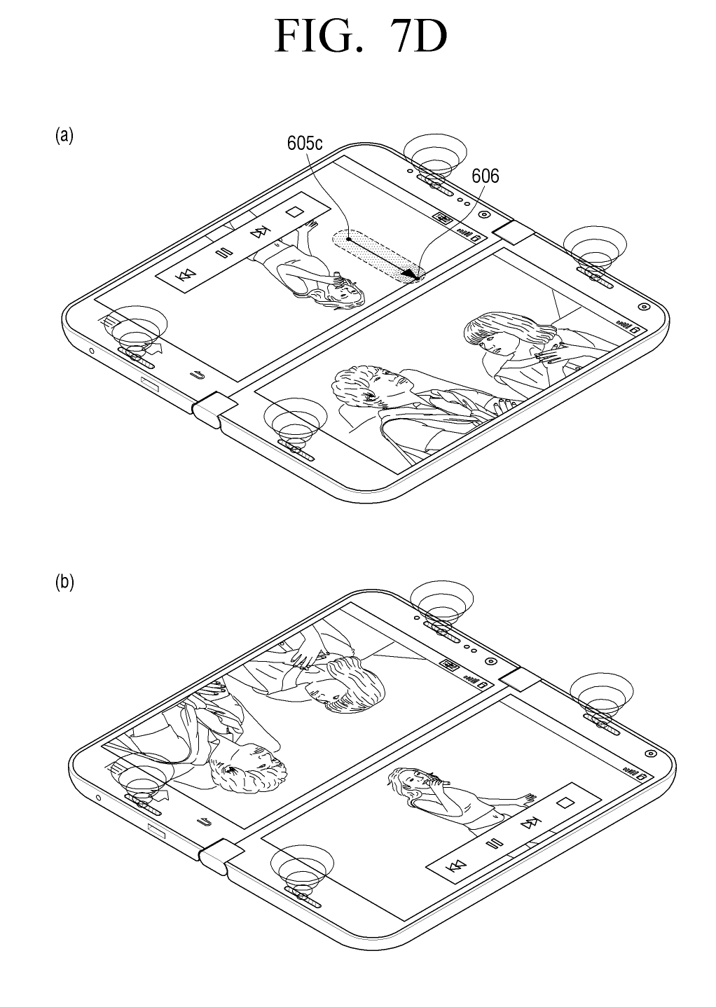

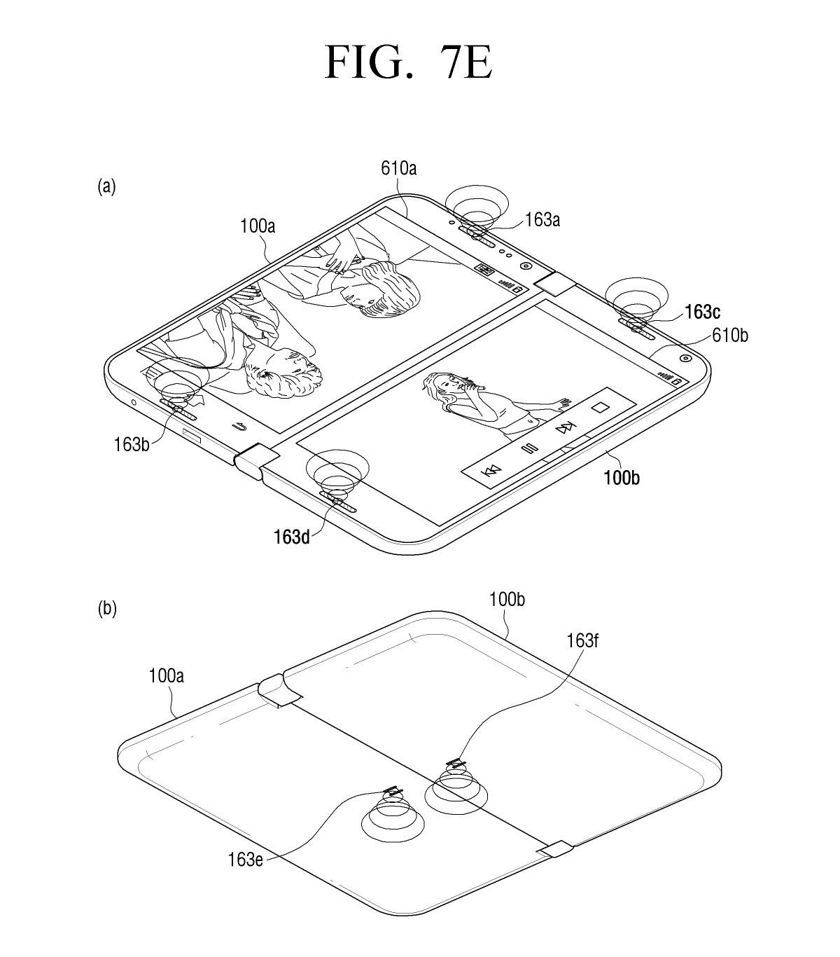

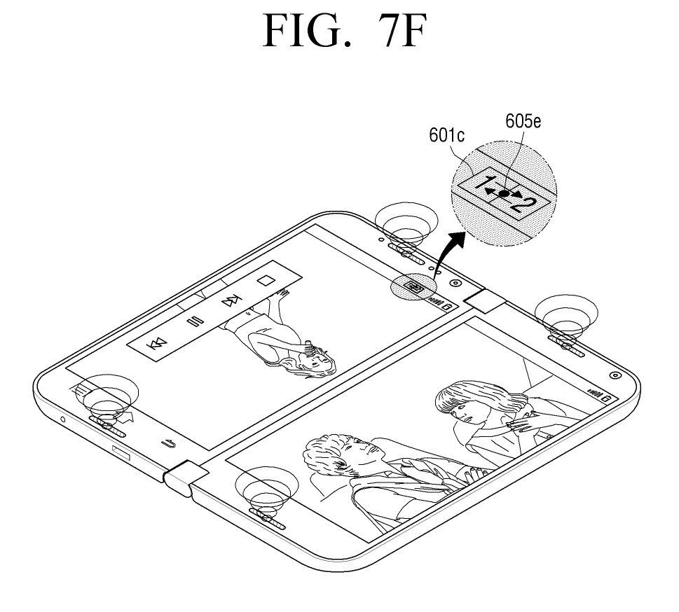

FIGS. 7A through 7F are views illustrating an example of a sound output method of a portable apparatus according to another exemplary embodiment of the present general inventive concept.

The angle between the first housing 100a and the second housing 100b in the exemplary embodiment of the present general inventive concept as illustrated in FIGS. 7A to 7F is different from that in the above-described exemplary embodiment of the present general inventive concept illustrated in FIGS. 6A to 6F. For example, the angle between the first housing 100a and the second housing 100b in FIGS. 6A to 6F is about 60 degrees, and the angle between the first housing 100a and the second housing 100b in FIGS. 7A to 7F is about 180 degrees. The exemplary embodiment of the present general inventive concept may be applied when the angle is an angle in which the 605 touch may be input to the first touch screen 190a of the first housing 100a and the second touch screen 190b of the second housing 100b through fingers or the input unit 167. For example, when the angle between the first housing 100a and the second housing 100b is about 360 degrees (when the first touch screen 190a and the second touch screen 190b face each other), the exemplary embodiment of the present general inventive concept may be implemented using other input types (for example, voice) other than the touch input. Even when the angle between the first housing 100a and the second housing 100b is an angle in which a touch 605 through fingers or the input unit 167 is impossible, the exemplary embodiment of the present general inventive concept may be implemented using other input types (for example, voice) other than the touch 605. The operations S501 to S509 of FIG. 5 are substantially the same as in FIGS. 6A to 6F and 7A to 7F, and thus repeated description thereof will be omitted.

FIGS. 8A to 8D are views illustrating a sound output method of a portable apparatus 100 according to various exemplary embodiments of the present general inventive concept.

Referring to view (a) of FIG. 8A, the portable apparatus 100 according to an exemplary embodiment of the present general inventive concept includes one speaker 163 (total 2 speakers 163a and 163c) in an upper portion of a front side of each of the first housing 100a and the second housing 100b. Referring to view (b) of FIG. 8A, there is no speaker 163 in back sides of the first housing 100a and the second housing 100b, according to the illustrated exemplary embodiment of the present general inventive concept.

The controller 110 may mutually exchange a screen 611a of a first application and a screen 611b of a second application in response to one of consecutive movement of a touch and a touch of a switching icon. The controller 110 may mutually exchange sounds (for example, 1 channel) output in the speaker 163a of the first housing 100a and the speaker 163c of the second housing 100b in response to the exchange of the screen 611a of the first application and the screen 611b of the second application. The controller 110 may control the sounds to be output through one speaker 163a and 163c disposed in each of the housings 100a and 100b as 1 channel.

Referring to view (a) of FIG. 8B, the portable apparatus 100 according to another exemplary embodiment of the present general inventive concept may include one speaker 163 (total 2 speakers 163a and 163c) in an upper portion of a front side of each of the first housing 100a and the second housing 100b. Referring to view (b) of FIG. 8B, one woofer speaker 163e is disposed only in a back side of the first housing 100a.

The controller 110 may control the sound to be output through two speakers 163a and 163e according to an application executed in the first housing 100a. The controller 110 may control the sound to be output through one speaker 163c according to an application executed in the second housing 100b.

The controller 110 may mutually exchange the screen 611a of the first application and the screen 611b of the second application in response to one of the consecutive movement of the touch 605 and the touch of the switching icon 601c. The controller 110 may mutually exchange sounds output from the speakers 163a and 163e of the first housing 100a and sound output from the speaker 163c of the second housing 100b in response to the exchange of the screen 611a of the first application and the screen 611b of the second application. The controller 110 may control the sound (for example, 1 channel) to be output through one speaker 163c of the second housing 100b by performing down-mixing

Referring to view (a) of FIG. 8C, the portable apparatus 100 according to another exemplary embodiment of the present general inventive concept includes two speakers 163 (total 4 speakers 163a, 163b, 163c, and 163d) in upper and lower portions of a front side of each of the first housing 100a and the second housing 100b. Referring to view (b) of FIG. 8C, there is no speaker 163 in a back side of each of the housing 100a and the second housing 100b.

The controller 110 may mutually exchange the screen 611a of the first application and the screen 611b of the second application in response to one of the consecutive movement of the touch and the touch of the switching icon. The controller 110 may mutually exchange sounds output from the speakers 163a and 163b of the first housing 100a and sounds output from the speakers 163c and 163d of the second housing 100b in response to the exchange of the screen 611a of the first application and the screen 611b of the second application. The controller 110 may control the sounds to be output through a plurality of speakers 163a, 163b, 163c, and 163d in the housings as 2 channels.

Referring to view (a) of FIG. 8D, the portable apparatus 100 according to another exemplary embodiment of the present general inventive concept includes two speakers 163 (total 4 speakers 163a, 163b, 163c, and 163d) in upper and lower portions of a front side of each of the first housing 100a and the second housing 100b. Referring to view (b) of FIG. 8D, one woofer speaker 163e is disposed only in a back side of the first housing 100a.

The controller 110 may control the sounds to be output through three speakers 163a, 163b, and 163e according to an application executed in the first housing 100a. The controller 110 may control the sounds to be output through two speakers 163c and 163d according to an application executed in the second housing 100b.

The controller 110 may mutually exchange the screen 611a of the first application and the screen 611b of the second application in response to one of the consecutive movement of the touch 605 and the touch of the switching icon 601c. The controller 110 may mutually exchange sounds output from the speakers 163a, 163b, and 163e of the first housing 100a and sounds output from the speakers 163c and 163d of the second housing 100b in response to the exchange of the screen 611a of the first application and the screen 611b of the second application. Combination and determination of a variety of output modes according to the channel number of contents and the number of speakers 163 in the housings 100a and 100b, will be easily understood by the person having ordinary skill in the art.

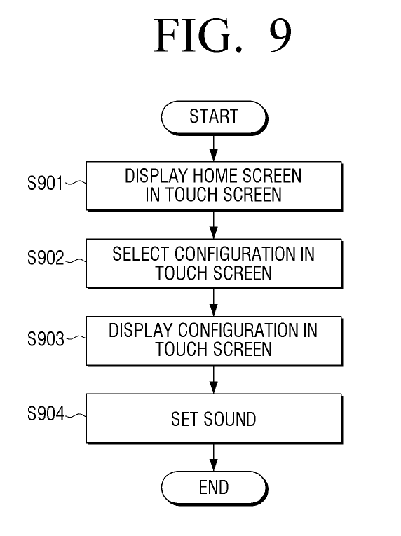

FIG. 9 is a schematic flowchart illustrating sound setting-up according to an exemplary embodiment of the present general inventive concept.

FIG. 10 is a view illustrating examples of a sound output mode setting-up according to an exemplary embodiment of the present general inventive concept.

In operation S901 of FIG. 9, a home screen (not illustrated) is displayed in the first touch screen 190a or the second touch screen 190b.

When a home button 161a2 in a lower portion of a front side of the first housing 100a (illustrated for example in FIG. 1A) is selected by the user, the home screen is displayed in the first touch screen 190a. When a home button 161b2 of the second button group 161b (illustrated for example in FIG. 1A) of the second housing 100b is selected, a home screen may be displayed in the second touch screen 190b. In the exemplary embodiment of the present general inventive concept, an example in which the home screen is displayed when the home button 161a2 of the first touch screen 190a is selected will be described.

In operation S902 of FIG. 9, a configuration 1000 is selected in the touch screen 190.

According to the present exemplary embodiment of the present general inventive concept, an icon (not illustrated) or a text corresponding to the configuration 1000 in the home screen displayed in the first touch screen 190a is selected by the user. Alternatively, the configuration 1000 may be selected by the user through a menu button 161a1 in a lower portion of a front side of the first housing 100a, illustrated for example in FIG. 1A.

In operation S903 of FIG. 9, the configuration 1000 is displayed in the touch screen 190.

View (a) of FIG. 10 is a view illustrating examples of sound setting-up according to the present exemplary embodiment of the present general inventive concept.

Referring to view (a) of FIG. 10, the controller 110 displays the configuration 1000 corresponding to a user input in the first touch screen 190a. Items of the displayed configuration 1000 include wireless and network 1001, calls 1002, sound 1003, display 1004, security 1005, and sound setting-up 1006. Addition or deletion of the items displayed in the configuration 1000 according to the performance or a structure of the portable apparatus 100 will be easily understood by the person having ordinary skill in the art.

In operation S904 of FIG. 9, sound is set.

When the sound setting-up 1006 of view (a) of FIG. 10 is selected, sound setting-up 1006 of view (b) of FIG. 10 is displayed.

Referring to view (b) of FIG. 10, when the angle between the first housing 100a and the second housing 100b is about 360 degrees, the sound setting-up 1006 may include at least one of angle setting-up 1006a to set sound exchange output to be OFF in response to screen mutual exchange, screen setting-up 1006b to set an application screen corresponding to touch of a shortcut displayed in the first touch screen 190a to be preferentially displayed in one of the first touch screen 190a and the second touch screen 190b, volume setting-up 1006c to set volume of a speaker 163 according to status information (for example, battery low, during calls) of the portable apparatus 100 or surrounding status information (for example, a noise level around the portable apparatus 100) of the portable apparatus 100, and distance setting-up 1006d to set a distance of the consecutive movement of the touch 605 to mutually exchange the screens 611a and 611b. Addition or deletion of items of the sound setting-up according to the performance or a structure of the portable apparatus 100 will be easily understood by the person having ordinary skill in the art.

After operation S904 of FIG. 9, the sound setting-up is terminated when the sound output mode setting-up is completed.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a Blu-Ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of outputting sound of a portable apparatus having a plurality of touch screens, the method comprising:
detecting a first touch corresponding to a first shortcut and a second touch corresponding to a second shortcut among a plurality of shortcuts displayed in at least one of the plurality of touch screens;
displaying a first application in a first touch screen and a second application in a second touch screen one by one in response to the first touch and the second touch;
detecting an angle between a first housing including the first touch screen and a second housing including the second touch screen;
determining one of a plurality of output modes based on the detected angle, an attribute of the first application, and an attribute of the second application; and
outputting sounds through a plurality of speakers according to the determined output mode.

2. The method of claim 1, wherein the displaying the first and second application comprises:
displaying a screen of the first application in one of the first touch screen and the second touch screen, and displaying a screen of the second application in the other of the first touch screen and the second touch screen.

3. The method of claim 1, wherein the attribute of each of the first and second applications comprises:
at least one selected from the group consisting of a name of the application, contents executable in the application, and contents executed in the application.

4. The method of claim 1, wherein:
the output mode comprises at least one of on/off of sound output and volume adjustment corresponding to each of the plurality of speakers; and
the outputting of the sounds includes outputting the sounds through speakers located in the first housing and speakers located in the second housing, according to the determined output mode.

5. The method of claim 1, wherein the outputting of the sounds comprises outputting the sounds by configuring the plurality of speakers as at least one of 2 channels, 2.1 channels, 4 channels, 5.1 channels, and 7.1 channels.

6. The method of claim 4, wherein the output mode is a mode which individually outputs a plurality of audio sources corresponding to contents executed in each of the plurality of applications through the plurality of speakers.

7. The method of claim 1, further comprising:
detecting a third touch in the first touch screen; and
mutually exchanging a display location of a screen of the first application and a display location of a screen of the second application in response to the consecutive movement of the detected third touch, the sounds output through the plurality of speakers being exchanged and output according to the mutual exchange of the display locations of the screens.

8. The method of claim 7, wherein the consecutive movement of the third touch is consecutive movement of the detected third touch from the first touch screen toward the second touch screen.

9. The method of claim 7, wherein the consecutive movement comprises any one of drag, flick, and rotation.

10. The method of claim 1, further comprising:
detecting a fourth touch in an object corresponding to exchange of a screen of the first application displayed in the first touch screen, and a screen of the second application; and
mutually exchanging display locations of the screen of the first application and the screen of the second application in response to the detected fourth touch, the sounds output through the plurality of speakers being exchanged and output according to the mutual exchange of the display locations of the screens.

11. A method of outputting sound of a portable apparatus having a plurality of touch screens and a plurality of speakers, the method comprising:
detecting a first touch corresponding to a first shortcut and a second touch corresponding to a second shortcut among a plurality of shortcuts displayed in the any one of touch screens;
displaying a first application and a second application in a first touch screen and a second touch screen one by one in response to the first touch and the second touch;
detecting an angle between the first touch screen and the second touch screen in one flexible housing including the first touch screen and the second touch screen by using a sensor;
determining an output mode based on the detected angle, an attribute of the executed first application, and an attribute of the second application, the attributes of the first and second applications including at least one of a name of the application and an extension of contents executed in the application; and
outputting sounds through the plurality of speakers according to the determined output mode.

12. A portable apparatus, comprising:
a plurality of speakers;
a first touch screen configured to display a plurality of shortcuts corresponding to a plurality of applications;
a second touch screen;
a sensor configured to detect an angle between the first touch screen and the second touch screen; and
a controller configured to control the plurality of speakers, the first touch screen, the second touch screen, and the sensor, the controller controlling the apparatus to detect a first touch corresponding to a first shortcut and a second touch corresponding to a second shortcut in the first touch screen, and display a first application and a second application in the first touch screen and the second touch screen, respectively, in response to the first touch and the second touch, and controlling the apparatus to determine an output mode based on the detected angle, an attribute of the first application, and an attribute of the second application, and output sounds through the plurality of speakers according to the determined output mode.

13. The portable apparatus of claim 12, further comprising:
a hinge configured to connect a first housing including the first touch screen and one or more speakers of the plurality of speakers, and a second housing including the second touch screen and one or more speakers of the plurality of speakers.

14. The portable apparatus of claim 13, wherein the sensor is located in at least one of the first housing, the second housing, and the hinge.

15. The portable apparatus of claim 13, wherein:
portions of the plurality of speakers are located in at least one of a front side of the first housing in which the first touch screen is located, a back side of the first housing, and a side of the first housing connecting the front side of the first housing and the back side of the first housing; and
portions of the plurality of speakers are located in at least one of a front side of the second housing in which the second touch screen is located, a back side of the second housing, and a side of the second housing connecting the front side of the second housing and the back side of the second housing.

16. The portable apparatus of claim 13, wherein:
the plurality of speakers includes at least one of a woofer and a center speaker; and
the woofer is located in one of the first housing and the second housing.

17. The portable apparatus of claim 12, wherein the controller mutually exchanges a display location of a screen of the first application and a display location of a screen of the second application in response to consecutive movement of a third touch detected in the first touch screen, and exchanges the sounds output through the plurality of speakers in response to the mutual exchange of the display locations and outputs the exchanged sounds through the plurality of speakers.

18. The portable apparatus of claim 12, wherein the controller mutually exchanges a display location of a screen of the first application and a display location of a screen of the second application in response to a fourth touch detected in an object displayed in the first touch screen corresponding to the exchange of the screen of the first application and the screen of the second application, exchanges the sounds output through the plurality of speakers according to the exchange of the display locations of the screens, and outputs the exchanged sounds through the plurality of speakers.

19. The portable apparatus of claim 12, further comprising:
one flexible housing including the plurality of speakers, the first touch screen, the second touch screen, and the sensor,
wherein an angle between the first touch screen and the second touch screen is measured in the flexible housing.

20. A method of outputting sound of a portable apparatus having a first touch screen and a second touch screen, the method comprising:
detecting a first touch corresponding to a first shortcut displayed in the first touch screen in a first housing including a first speaker group and the first touch screen;
executing a first application corresponding to the first shortcut and displaying the first application in a second touch screen of a second housing including a second speaker group and the second touch screen and separated from the first housing;
detecting a second touch corresponding to a second shortcut in the first touch screen;
executing a second application corresponding to the second shortcut and displaying the second application in the first touch screen; and
outputting sounds in the second speaker group according to a first output mode of a plurality of output modes determined based on an attribute of the first application, and outputting sounds in the first speaker group according to a second output mode of the plurality of output modes determined based on an attribute of the second application.

21. The method of claim 20, further comprising:
mutually exchanging a display location of a screen of the first application and a display location of a screen of the second application in response to a third touch detected in the first touch screen;
exchanging the sounds output through the first speaker group and the sounds output through the second speaker group according to the mutual exchange of the display locations; and
outputting the exchanged sounds.

22. The method of claim 20, further comprising:
determining an angle between the first housing and the second housing,
wherein the angle is determined using at least one of an angle sensor embedded in the portable apparatus and a user input.

23. A non-transitory computer-readable recording medium to contain computer-readable codes as a program to execute the method of claim 1.

24. A portable apparatus, comprising:
a first touch screen;
a second touch screen;
a sensor configured to detect a status of the portable apparatus; and
a controller configured to control the first touch screen, the second touch screen, and the sensor, the controller controlling the first touch screen and the second touch screen to display a first application and a second application, respectively, and determine an output mode of the apparatus based on the detected status, the first application, and the second application.

25. The portable apparatus of claim 24, wherein the controller outputs sounds through a plurality of speakers according to the first and second applications and the determined output mode.

26. The portable apparatus of claim 24, further comprising an input unit configured to interact with the first and second touch screens.

27. The portable apparatus of claim 26, wherein the input unit provides haptic feedback to a user.

28. The portable apparatus of claim 24, wherein the sensor comprises at least one of a proximity sensor, an angle sensor, an illuminance sensor, an acceleration sensor, a gyro sensor, a gravity sensor, and an altimeter.

29. A method of operating a portable apparatus having a plurality of touch screens, the method comprising:
displaying a first and a second application respectively in a first and a second touch screen;
detecting a status of the portable apparatus; and
determining an output mode of the portable apparatus based on the detected status and the first and second applications.

30. The method of claim 29, further comprising:
providing haptic feedback according to the determined output mode and touch inputs on the first and second touch screens.
